(19) United States
(12) Patent Application Publication
(10) Pub. No.: US 2020/0066049 A1
(43) Pub. Date: Feb. 27, 2020

(54) System and Method for Collaborative Learning Using Virtual Reality

(71) Applicant: Digital Pulse Pty. Limited, Crows Nest (AU)

(72) Inventors: Han Sun, Crows Nest (AU); Tracey Taylor, Crows Nest (AU); Craig Somerville, Crows Nest (AU); Phillip Sullivan, Crows Nest (AU); Hai Tran, Crows Nest (AU); Daragh Casey, Crows Nest (AU)

(21) Appl. No.: 16/467,777

(22) PCT Filed: Dec. 8, 2017
(86) PCT No.: PCT/IB2017/057761

§ 371 Date: Jun. 7, 2019

(30) Foreign Application Priority Data
Dec. 8, 2016 (AU) 2016905071

(51) Int. Cl. G06T 19/00; A63F 13/211; A63F 13/212; A63F 13/25; G06F 3/01; G02B 27/01; G06F 3/0481

(52) U.S. Cl. CPC G06T 19/006; A63F 13/211; A63F 13/212; A63F 13/25; A63F 2300/8082; G06F 3/017; G02B 27/017; G06F 3/04815; G02B 2027/014; G06F 3/011

(57) ABSTRACT

A virtual reality (VR) system for providing engagement of a super actor with a plurality of user actors and enabling interaction and collaboration between the user actors in association with interactive content in a VR environment. A processing system provides logic and control operations, networking functionalities and content management services directly to the super actor and user actors within a group and the particular interactive content associated with that group. Each of the devices are configurable to activate a package comprising data technically describing one or more discrete virtual worlds. This data comprises a prescribed array of items corresponding to different item types, where each virtual world is customised with items to provide prescribed functionality to the particular actor and to the particular content to be associated with the virtual world. The item types are characterised within the VR headset to create a virtual world capable of providing interaction and collaboration between: (i) a plurality of user actors; (ii) user actors and interactive content and (iii) super actors and user actors.

### FIELD OF THE INVENTION

This invention relates to a system and method for collaborative engagement and interaction in a virtual reality (VR) world. The invention has particular, but not exclusive, utility in the education and training sector for organised classroom style teaching and learning involving a teacher and a group of students, but using virtual reality systems and methods to provide a diverse and enhanced visual interactive learning experience between participants.

Throughout the specification, unless the context requires otherwise, the word “comprise” or variations such as “comprises” or “comprising”, will be understood to imply the inclusion of a stated integer or group of integers but not the exclusion of any other integer or group of integers.

### BACKGROUND ART

The following discussion of the background art is intended to facilitate an understanding of the present invention only. It should be appreciated that the discussion is not an acknowledgement or admission that any of the material referred to was part of the common general knowledge as at the priority date of the application.

Virtual reality (VR) experiences that are educationally focused have brought about what many in the community consider to be a more practical and utilitarian use of VR technology that has previously been considered to be more of an entertainment and leisure-based pursuit. Consequently, government and industry have rallied behind the rapid development of VR, resulting in various organisations developing new types of VR training and learning experiences.

These have ranged from simply playing immersive education panorama videos, which is a very basic VR experience, to more sophisticated single player VR experiences where players can experience a more interactive educational VR experience, to multiplayer VR experiences, where players can play a collaborative or competition game online.

The experiences offered to date each have drawbacks. In the case of the simple immersive educational panoramas, there is no facility for collaboration and updating of contents during the immersive experience.

In the case of the single player VR experience, whilst players can interact with objects in order to complete an educational experience, the player cannot learn how to collaborate with others. Most single player VR experiences have fixed content. Expanding this type of experience to the classroom would require a personal computer (PC) for each player, which is unrealistic in most schools. Furthermore, the teacher cannot readily interact with the students in the context of the VR experience, as it is only single user based.

In the case of the multiplayer VR experience, these are generally offered online and can involve interaction and collaboration between players in the same scenario or game, however there is no practical facility for involving a teacher who can supervise students participating in the game and transform the experience into a classroom style that is truly educational.

More recently, the problem of providing an interactive VR experience to a large number of users collaborating or competing in a classroom style has been highlighted as a significant problem to be addressed in order to expand VR teaching and learning experiences to schools.

One solution to the problem involves an immersive VR system for larger, theatre-sized audiences which enables multiple users to collaborate and work together as a group or enable groups to compete, however, these systems 10 to be more entertainment based and focused on providing an immersive VR experience based on action and dynamic content, rather than more experiential learning and education-based content.

Another solution involves creating a content controllable three-dimensional virtual world in a classroom environment that enables superficial collaboration between a teacher and students regarding content such as an observable object in the virtual world. However, these provide very basic collaboration between users do not involve actual interaction with the content that enables a deeper learning or training experience to be achieved.

Consequently, there is a need for a multi-user group focused VR experience that is capable of more greater collaboration between actors in a VR world and interaction with manageable content created in that world.

### DISCLOSURE OF THE INVENTION

It is an object of the present invention to provide a diverse and collaborative learning and educational experience using VR that is able to be used in schools adopting a classroom style teaching and learning experience.

In accordance with one aspect of the present invention, there is provided a virtual reality (VR) system for providing engagement of a super actor with a plurality of user actors and enabling interaction and collaboration between the user actors in association with interactive content including avatars of the user actors in a VR environment, the VR platform comprising:

a processing system to provide:
(i) logic and control operations of one or more groups of super actors and user actors, and networking functionalities between devices of the super actors and user actors and other devices associated with the VR system; and
(ii) content management services directly to the super actor and user actors within a group and the particular interactive content associated with the group;
   the device of the super actor comprising a monitor including an intelligent processor, and the devices of the user actors each comprising a VR headset including an intelligent processor;
   each of the devices being configurable to activate a package comprising data technically describing one or more discrete virtual worlds, the data comprising a prescribed array of items corresponding to different item types, each virtual world being customised with items to provide prescribed functionality to the particular actor and to the particular content to be associated with the particular virtual world;
   wherein the item types are characterised within the VR headset to create a virtual world capable of providing interaction and collaboration between:
(a) a plurality of user actors;
(b) user actors and interactive content; and
(c) super actors and user actors;
   by including:
(i) networking properties associated with interactive content providing synchronisation states substantially continuously to enable the interactive content to be synchronised amongst the devices;
(ii) group settings for the virtual world; and
(iii) a user interface for the devices to enable the devices to control the virtual world and trigger functionalities therein or associated therewith.

Preferably, the interactive content includes an interactive object comprising interactive segments, whereby each avatar, interactive object and interactive segment individually includes networking properties to substantially continuously issue synchronisation states thereof.

Preferably, the item types further include any one or more of the following:
(i) video including planar video, panorama or panorama video, or any combination of these;
(ii) timing, scoring or player list, or any combination of these;
(iii) logic sequencing or customised messaging, or any combination of these;
(iv) avatar assets including avatar dynamic attachment, avatar customised animation or customised avatar, or any combination of these;
(v) movement including view range control, freeze camera, path or teleporting, or any combination of these;
(vi) notation;
(vii) positioning, including sweep, gaze in, gaze out, tapping, holding or positional input, or any combination of these;
(viii) object interaction including Interactive object, heat point or slot, or any combination of these.

In accordance with another aspect of the present invention, there is provided a virtual reality (VR) platform for teaching and learning involving interaction between a teacher actor and a plurality of student actors, the VR platform comprising: a VR application having a plurality of processes to enable the performance of a plurality of use cases enabling interaction between: (i) a teacher actor, (ii) a student actor, and (iii) spawned instances of the teacher actor and student actor and a plurality of interactive objects all forming part of a VR activity in a virtual environment using tools of a software development toolkit to perform VR functionalites; a plurality of teacher use cases to allow a teacher actor to interact with a VR application to:
(i) organise a plurality of student actors to interact with an interactive task object and each other for teaching and learning collaboration and interactive skills in a collaborative and competitive manner, whereby the interactive task object is defined within a VR activity and comprises a plurality of interactive component objects;
(ii) control interaction associated with the VR activity and the competitive participation of student actors; and
(iii) monitor the competitive participation of student actors associated with the VR activity; and
   a plurality of student use cases to allow a student actor to interact with the VR application to participate in the VR activity including interacting to:
(a) gaze at an interactive object within the VR activity as a means of selecting the interactive object;
(b) grab an interactive object within the VR activity as a means of holding the interactive object;
(c) place a grabbed interactive object within the VR activity as a means of moving the interactive object;
(d) rotate the head of a spawned instance of a student actor within the VR activity as a means of changing the view of the student actor within the virtual environment.

In accordance with another aspect of the present invention, there is provided a virtual reality (VR) application for a VR platform for teaching and learning involving interaction between a teacher actor and a plurality of student actors, the VR application comprising:

a plurality of processes to enable the performance of a plurality of use cases enabling interaction between: (i) a teacher actor, (ii) a student actor, and (iii) spawned instances of the teacher actor and student actor and a plurality of interactive objects all forming part of a VR activity in a virtual environment using tools of a software development toolkit to perform a set of VR functionalites;
wherein one of the processes is a design process for designing an interactive task object comprising interactive component objects for use in the virtual environment, the design process including:
an object model function for creating a virtual task model of an interactive task object;
a model division function for dividing the virtual task model into virtual component models of interactive component objects;
a model component removal function to remove selected virtual component models from the virtual task model leaving one or more empty slots in the virtual task model;
a visual testing function for enabling visual inspection of the virtual task model to determine whether the visual range of an empty slot is within a prescribed viewing range from one viewing perspective of the virtual task model, and that the configuration of the empty slot cannot be seen from one or more alternative viewing perspectives around the virtual task model;
a collider adding function to enable a collider to be added to:
(i) an empty slot, whereby the collider is substantially the same size as the removed virtual component model that fits the empty slot;
(ii) a removed virtual component, so that the collider is bigger than and envelops the removed virtual component model;
   the collider adding function including a collision function responsive to detecting a searching signal colliding with a collider and triggering an event for initiating further logic in response to the collision.

In accordance with a further aspect of the present invention, there is provided a virtual reality (VR) application for a VR platform for teaching and learning involving interaction between a teacher actor and a plurality of student actors, the VR application comprising:

a plurality of processes to enable the performance of a plurality of use cases enabling interaction between: (i) a teacher actor, (ii) a student actor, and (iii) spawned instances of the teacher actor and student actor and a plurality of interactive objects all forming part of a VR activity in a virtual environment using tools of a software development toolkit to perform a set of VR functionalites;
wherein the processes include:
(i) a plurality of teacher actor processes for synthesising interactions to implement case uses for a teacher actor to:
(a) organise a plurality of student actors to interact with an interactive task object and each other for teaching and learning collaboration and interactive skills in a collaborative and competitive manner, whereby the interactive task object is defined within a VR activity and comprises a plurality of interactive component objects;
(b) control interaction associated with the VR activity and the competitive participation of student actors;
(c) monitor the competitive participation of student actors associated with the VR activity; and
(ii) a plurality of student actor processes for synthesising interactions to implement case uses for a student actor to participate in the VR activity including interacting to:
(a) gaze at an interactive object within the VR activity as a means of selecting the interactive object;
(b) grab an interactive object within the VR activity as a means of holding the interactive object;
(c) place a grabbed interactive object within the VR activity as a means of moving the interactive object;
(d) rotate the head of a spawned instance of a student actor within the VR activity as a means of changing the view of the student actor within the virtual environment.

In accordance with another aspect of the present invention, there is provided a method for teaching and learning involving interaction between a teacher actor and a plurality of student actors in a virtual reality (VR) environment, including:
(1) for a teacher actor:
(a) organising a plurality of student actors to interact with an interactive task object and each other for teaching and learning collaboration and interactive skills in a collaborative and competitive manner, whereby the interactive task object is defined within a VR activity and comprises a plurality of interactive component objects;
(b) controlling interaction associated with the VR activity and the competitive participation of student actors; and
(c) monitoring the competitive participation of student actors associated with the VR activity; and
(2) for a student actor to participate in the VR activity:
(a) gazing at an interactive object within the VR activity as a means of selecting the interactive object;
(b) grabbing an interactive object within the VR activity as a means of holding the interactive object;
(c) placing a grabbed interactive object within the VR activity as a means of moving the interactive object;
(d) rotating the head of a spawned instance of a student actor within the VR activity as a means of changing the view of the student actor within the virtual environment.

In accordance with another aspect of the present invention, there is provided a method for providing engagement of a super actor with a plurality of user actors and enabling interaction and collaboration between them in association with interactive content in a VR environment, including avatars of the user actors, including:

providing logic and control operations of one or more groups of super actors and user actors, and networking functionalities between devices of the super actors and user actors in the VR environment;
providing content management services directly to the super actor and user actors within a group and the particular interactive content associated with the group;
activating a package comprising data technically describing one or more discreet virtual worlds, the data comprising a prescribed array of items corresponding to different item types, each virtual world being customised with items to provide prescribed functionality to the particular actor and to the particular content to be associated with the particular virtual world;
the item types being characterised within the devices of the user actors to create a virtual world capable of providing interaction and collaboration between:
(a) a plurality of user actors;
(b) user actors in interactive content; and
(c) super actors in user actors;
   by including:
(1) networking properties associated with interactive content providing synchronisation states substantially continuously to enable the interactive content to be synchronised amongst the devices;
(2) group settings for the virtual world; and
(3) a user interface for the devices to enable the devices to control the virtual world and trigger functionalities therein or associated therewith.

In accordance with a further aspect of the present invention, there is provided a method for designing an interactive task object comprising interactive component objects for use in a virtual reality (VR) environment for teaching and learning involving interaction between a teacher actor and a plurality of student actors, the method including:

creating a virtual task model of an interactive task object;
dividing the virtual task model into virtual component models of interactive component objects;
removing selected virtual component models from the virtual task model leaving one or more empty slots in the virtual task model;
providing for visual inspection of the virtual task model to determine whether the visual range of an empty slot is within a prescribed viewing range from one viewing perspective of the virtual task model, and that the configuration of the empty slot cannot be seen from one or more alternative viewing perspectives around the virtual task model;
adding colliders to:
(i) an empty slot, whereby the collider is substantially the same size as the removed virtual component model that fits the empty slot;
(ii) a removed virtual component, so that the collider is bigger than and envelops the removed virtual component model; and
   detecting a searching signal colliding with a collider and triggering an event for initiating further logic in response to the collision.

### BRIEF DESCRIPTION OF THE DRAWINGS

The invention will be better understood having regard to the best mode for carrying out the invention, which is described with reference to the following drawings, wherein:—

FIG. 1 is a schematic diagram showing a high level system overview of the VR platform in accordance with the first embodiment;

FIG. 2 is a use case diagram showing the interaction and functions that are able to be performed by the different users of the VR platform in accordance with the first embodiment;

FIG. 3 is a VR display screen image showing the in waiting room area for students in accordance with the first embodiment;

FIG. 4 is a VR display screen image showing a teacher perspective in the activity room during an activity involving a first group of students in accordance with the first embodiment;

FIG. 5 is a VR display screen image showing the podium or waiting room area for students from a student perspective in accordance with the first embodiment;

FIG. 6 is a VR display screen image showing a student perspective from their activity location in the activity room during their participation in the activity in accordance with the first embodiment;

FIG. 7 is a VR display screen image showing a teacher perspective in the activity room during an activity involving a second group of students in accordance with the first embodiment;

FIG. 8 is a VR display screen image of another student perspective from their activity location in the activity room on completion of the activity in accordance with the first embodiment;

FIG. 9 is a flow chart of the GroupStudents process for implementing the Group Students use case in accordance with the first embodiment;

FIG. 10 is a flow chart of the InteractiveContentControl process for implementing the Interactive Content Control use case in accordance with the first embodiment;

FIG. 11 shows a series of graphic images of the virtual controller in different states in accordance with the first embodiment;

FIG. 12 is a flow chart of the Teleporting process for implementing the Teleporting use case in accordance with the first embodiment;

FIG. 13 is a graphical representation of the teleporting drop-down box displayed as part of the Teleporting process;

FIG. 14 is a flow chart of the PlayerStateList process for implementing the Player State List use case in accordance with the first embodiment;

FIG. 15 is a graphical representation of the player list displayed is part of the PlayerStateList process;

FIG. 16 is a student state diagram for a student object in accordance with the first embodiment;

FIG. 17 is a student timer state diagram for a student timer object in accordance with the first embodiment;

FIG. 18 is a group timer state diagram for a group timer object in accordance with the first embodiment;

FIG. 19 is a flow chart of the DesignActivity process for creating a puzzle to function as an interactive task object for a game activity in accordance with the first embodiment; and

FIG. 20A to FIG. 20I are a series of virtual diagrams showing the steps involved with creating a puzzle in accordance with the flow chart of the DesignActivity process of FIG. 19 in accordance with the first embodiment;

FIG. 21 is a block diagram showing an overview of the VR system in accordance with the second embodiment of the best mode;

FIG. 22 is a series of content structure diagrams in accordance with the second embodiment, wherein:

(i) FIG. 22a shows the content structure of the game control server, the tablet device of the super actor, and the VR headset devices of two user actors;

(ii) FIG. 22b shows the content structure of a package; and

(iii) FIG. 22c shows the content structure of the item types;

FIG. 23a is a content structure diagram showing the items used to describe an example of a world in a package being in the form of an earth puzzle, in accordance with the second embodiment; and

FIG. 23b is a VR display screen image showing a stage of the earth puzzle world of FIG. 23a;

FIG. 24 are to structure diagrams of the earth puzzle world example, wherein:

(i) FIG. 24a shows the implementation of the earth puzzle world in accordance with the first embodiment structure; and

(ii) FIG. 24b shows the implementation of the earth puzzle world in accordance with the first embodiment structure.

### BEST MODE(S) FOR CARRYING OUT THE INVENTION

The best mode for carrying out the invention involves two specific embodiments of the invention, both directed towards a virtual reality (VR) system comprising a VR platform based on a remote host that communicates with a number of school network systems through a distribution server across a wide area network (WAN). The VR platform serves VR content to the school network systems, including content in the form of video and interactive content particularly, but not exclusively, concerning collaborative educational activities. A specific collaborative educational activity and/or video can be selected and downloaded from a contents database on the host, directly by individual teachers within the school. An individual teacher can then host the activity for students to access using VR gear within a classroom environment, as part of a lesson within a subject in a field of study prescribed by the school.

The first specific embodiment is directed towards a computer network system including a VR platform with a cloud based distribution server and services that are connected via a network such as the Internet to individual school network systems.

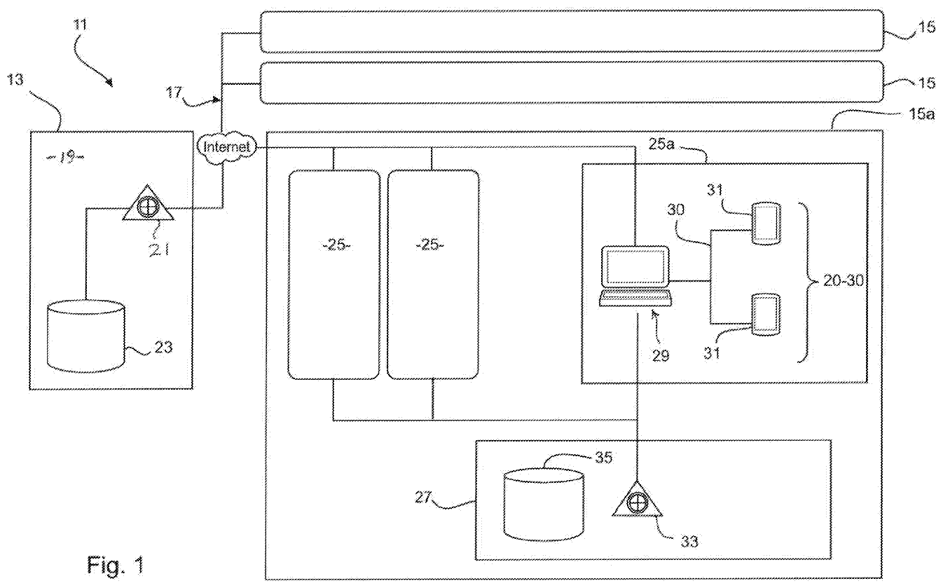

As shown in FIG. 1, the VR platform forms part of a computer networked processing system 11 comprising a host 13 and a plurality of school networks 15 that communicate with each other over a WAN, which in the present embodiment is the Internet 17.

The host 13 includes a distribution server 19 that hosts a distribution web service 21, which accesses content stored in a contents database 23.

The school networks 15 are each dedicated to a particular school, whereby an individual school network 15a includes a plurality of classroom local networks 25, each dedicated to a particular classroom of the school, which are networked to a master school student authentication system 27 for controlling communications and administering all users of the school networks 15 and classroom local networks 25.

An individual classroom local network 25a includes a teacher terminal 29 device and a plurality of student terminals 31 devices, which typically number 20 to 30, one for each student. In the present embodiment, each teacher terminal 29 comprising a monitor including an intelligent processor such as a touchscreen laptop or tablet, which maintains a VR application for providing content management services, including accessing, downloading and running VR content from the host 13 and administering appropriate educational resources for the classroom. Each student terminal 31 on the other hand is deployed on VR gear comprising a VR headset including an intelligent processor, such as the Samsung Gear VR™, to participate in a specific collaborative educational activity or view a linear video as part of the VR content downloaded to them under the supervision of the teacher from their teacher terminal 29.

The master school student authentication system 27 hosts a login web service 33 for each user within a particular school network 15, which allows controlled access to a students database 35 for storing student accounts and information. A teachers database (not shown), provided within the same database management system as for the students database 35, for storing teacher accounts and information is provided for access by teachers to log onto a school teacher authentication system (not shown) using the same or similar login web service 33, to allow access to the classroom local network 25 and host 13.

An important consideration in the design of the processing system 11 is the provision of logic and control operations of one or more groups of devices comprising teacher terminals 29 and student terminals 31, and networking connectivity and functionalities between devices, especially between a teacher terminal 29 and a student terminal 31. A limitation of previous VR systems having applications within the education and training sector has involved a teacher not being able to simultaneously display the content to multiple devices at the same time and monitor what students are seeing in a virtual world of the VR environment.

The present embodiment addresses the network connectivity between a student terminal 31 and a teacher terminal 29 by using the Software Development Kit (SDK) provided by Unity3D™ and maintaining network connections between student terminals and the teacher terminal using UNET™. These tools allow the VR application to be built using a multiplayer foundation that provides for the following features:
a high-performance transport layer based on UDP (User Datagram Protocol) to support different interactive content
low-level API (LLAPI), which provides complete control through a socket like interface
high level API (HLAPI), which provides a simple and secure client/server network model
Matchmaker Service that provides basic functionality for creating rooms and helping students find other students to play with
Real Server, which solves connectivity problems for the teacher and students trying to connect to each other behind the school firewall.

Consequently, these tools enable the interactive content to be created with networking properties that provide for synchronisation states substantially continuously, thus enabling the interactive content to be synchronised amongst the various devices, including both the teacher terminal 29 and the student terminals 31 within a group.

Furthermore, the tools also provide for group settings to be created for the virtual world in which the interactive content is presented and a user interface for the devices to enable them to control the virtual world and trigger functionalities within it and associated with it.

Another consideration that the present embodiment addresses is the publishing of new content and making it available to the school networks in a seamless manner. It does this by way of the distribution server 19 being designed to publish the two kinds of VR content provided by the VR platform, namely video and interactive content, by way of the distribution web service 21. In this manner, teachers in different schools can request details of educational resources including VR content simply by sending an HTTP (Hypertext Transfer Protocol) request using the VR application provided on their teacher terminal 29 to the distribution server 19. The distribution server 19 is designed to respond to such a request by providing a copy of a current VR content list stored within a library on the host 13, indicating available VR content for downloading stored in the contents database 23. This current content list is continuously updated by the host 13 whenever new VR content becomes available and is stored in the contents database 23.

The contents database 23 is able to store all digital educational resources associated with a lesson as part of the syllabus to be taught by a teacher as discrete packages of VR content. A package will comprise as binary files: (i) all videos, graphical and textual material, including slides and reading material; and (ii) interactive content including one or more collaborative educational activities; all associated with a virtual world created for delivering a particular lesson. A single package comprises data that can technically describe one or more discrete virtual worlds and the VR platform can support VR content in the form of 3-D/360° and panorama videos, as well as planar/linear videos.

The interactive content includes data comprising a prescribed array of items that correspond to different item types and is stored in a container as prefab files. Prefab is a type of asset used in Unity™ that functions as a reusable object stored in a project view of the particular VR experience that has been designed in the one or more virtual worlds of a package. The item types are characterised within the VR headset to create a virtual world capable of providing interaction and collaboration between:
(i) a plurality of student actors 43;
(ii) student actors 43 and interactive content; and
(iii) teacher actors 41 and student actors 43.
   Thus each virtual world is customised with items to provide prescribed functionality to the particular actor and to the particular content to be associated with the particular virtual world.

These prefab files can be inserted into any number of scenes, multiple times per scene. In the present embodiment, both video content and interactive content are encrypted before publishing.

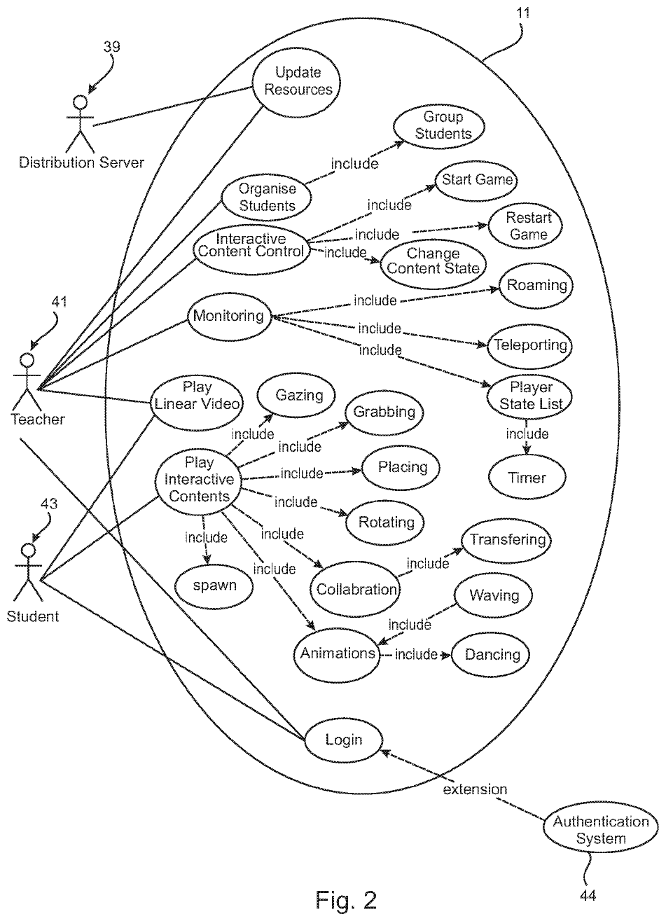

The functional interaction of users with the processing system 11 is best shown in the use case diagram of FIG. 2. The processing system 11 essentially accommodates for three types of users as actors within the system: a distribution server actor 39, a super or teacher actor 41 and a user or student actor 43.

As shown, a distribution server actor 39 and a teacher actor 41 interact with the use case Update Resources to access educational resources and VR content on the host 13. In the case of the distribution server actor 39, compressed packages of discrete educational resource material are uploaded to the distribution server 19 and stored on the contents database 23 as either new or updated material for a particular lesson In the case of a teacher actor 41, links to these packages including the VR content are made available via the VR application that is run on the teacher terminal 29 of the particular teacher actor 41.

The VR application is programmed and the teacher terminal 29 device is configurable to allow a teacher actor 41 to:
(i) download a number of packages comprising educational resources from the distribution server 19 first, including VR content and specifically collaborative educational activities;
(ii) decompress the relevant files; and
(iii) store these in a collection facility or library on the teacher terminal 29 for use when appropriate.

When convenient, the teacher actor 41 can then use the VR application to populate or update all student terminals 31 within the classroom to participate in a particular lesson with VR content by downloading all relevant files in a package under the control and close supervision of the teacher.

Importantly, each teacher terminal 29 effectively functions as a host for running the VR content including any collaborative educational activity; and the student terminals 31 function as clients, networked into the teacher terminal, accessing the same content, but from individually customised perspectives.

The student terminals 31 are designed to store particular VR content received by them from the teacher terminal 29 in a cache (not shown). This allows the student terminals 31 to rapidly access and run the content, when a particular student actor 43 is chosen by the teacher actor 41 to participate in a VR session involving the content as part of a lesson. The VR application is designed so that the student actor is required to firstly enroll by interacting with the Login use case, and then can access the content rapidly in the cache, rather than spend time downloading the content from the teacher terminal 29 each time. This allows more efficient use of student-teacher time to actively participate in the lesson, rather than be held up technological downloading delays.

In the present embodiment, all student terminals 31 in a classroom connect to the teacher terminal host 29 through a wireless local network 30. As would be appreciated, other embodiments include using a wired local network.

By virtue of this master-slave networking arrangement, a teacher can organise, manage and monitor the progress of each student participating not only in the lesson using non-VR resources, but importantly is a teacher actor in the VR content aspects of the lesson, and especially the collaborative educational activity, all from the teacher terminal 29. In order to achieve this, a teacher actor 41 at his/her discretion, interacts with the use cases Organise Students, Interactive Content Control, and Monitoring.

Interaction with the use case Organise Students can be extended to include teacher interaction with the use case Group Students. Interaction with the use case Interactive Content Control can be extended to include teacher interaction with the use cases Start Game, Restart Game and Change Content State. Finally, interaction with the use case Monitoring can be extended to include teacher interaction with the use cases Roaming, Teleporting and Player State List. The latter can be further extended to include teacher interaction with the use case Timer.

Each student actor 43 can perform interactions by sweeping or tapping on the touchpad of their VR gear. As indicated by the use case Group Students, student actors 43 are grouped by the teacher actor 41, which occurs after each individual student actor participating in the session is enrolled by way of the school student authentication system 27. Once enrolled, the student actor 43 can then interact with the content under the control of the teacher actor to play and watch linear videos by interacting with the use case Play Linear Video or participate in competitions between groups using the collaborative educational activity by interacting with the use case Play Interactive Contents.

Current high school IT systems are typically based on Windows authentications, which are managed by the school student authentication system 27. The VR platform is therefore designed to allow student actors to login with their windows account, previously established using the login web service 33. This enables the VR platform to synchronise a student's and a teacher's personal information stored on the students database 35 and the teachers database with content being watched or participated in. This is achieved by way of the school authentication system 44, which includes both the school student authentication system 27 and the school teacher authentication system, being extended to interact with the use case Login of the system pursuant to a teacher actor 41 or student actor 43 interacting with the use case Login when accessing the processing system 11.

When a student actor 43 is participating in interactive content by interacting with the use case Play Interactive Contents, important functionality is provided by the VR application to enable interactions with the collaborative educational activity being played. This also involves interactions and collaboration with other student actors participating with the activity and the teacher actor 41 all at the same time.

Due to the use of VR gear, student actor players cannot use extensive user interface controls such as keyboards and mouse when participating in the activity. All they can use are sensors and buttons provided on the headset that forms part of the VR gear. Similarly, given the expanded learning potential provided within a VR experience, communication techniques supporting collaboration are encouraged. Consequently, the VR application has included a number of innovative and strategic use cases that are extended from the Play Interactive Contents use case in order to enable student actor interaction with the activity and for collaborating with other student actors. These use cases include Gazing, Grabbing, Placing, Rotating, Collaboration and Animations. The use case Collaboration can be extended to include the student interacting with the use case Transferring, and the use case Animations can be extended to include the student actor interacting with the use cases Waving and Dancing to provide an extensive range of communication and interactive component object manipulation techniques.

Whilst a student actor 43 is participating in an activity arising from interacting with the use case Play Interactive Contents, a representation of an instance of the student actor as a virtual object within the VR activity at different positions or spots in different scenes is provided by including the student actor interacting with the use case ‘spawn’ as an extension of the Play Interactive Contents use case. Object spawning is a functionality made available by the VR application using appropriate tools within the SDK used in the present embodiment.

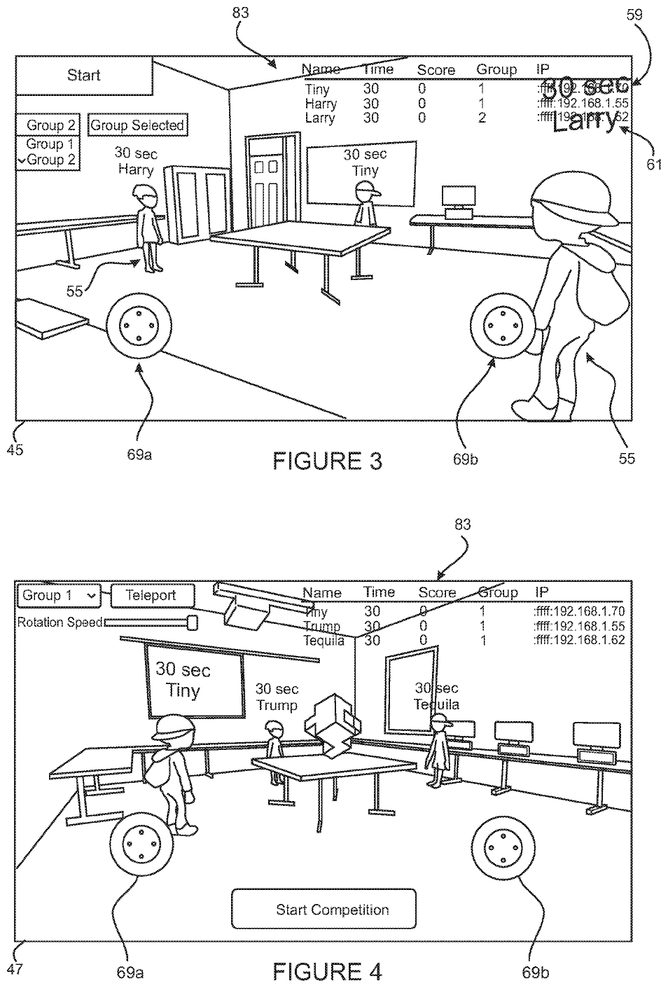

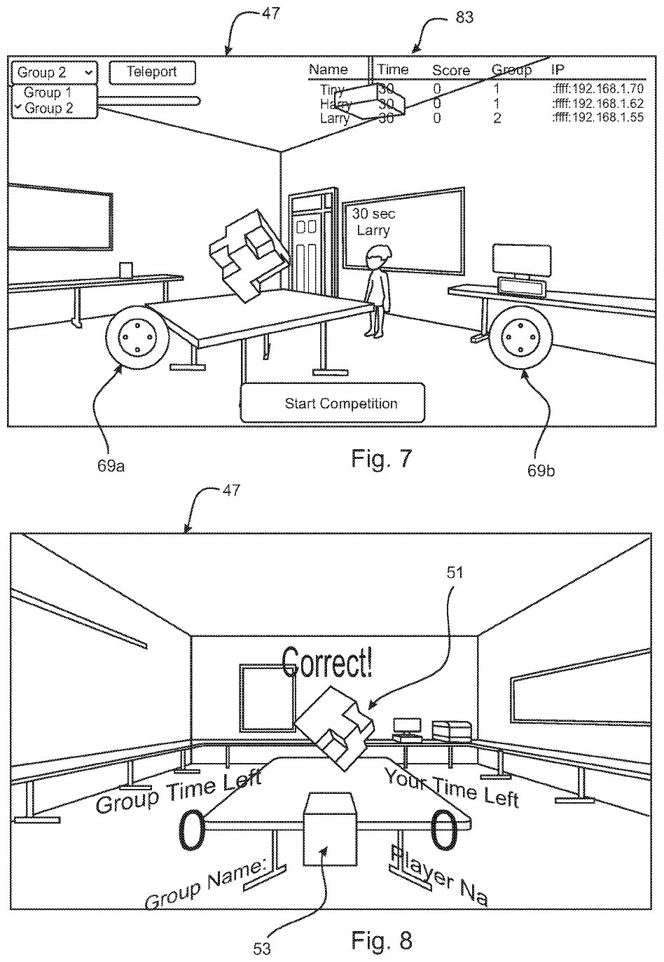

The most important use cases provided by the VR application of the processing system 11 will now be described by reference to various scenes taken from an exemplary collaborative educational activity as shown in FIGS. 3 to 8.

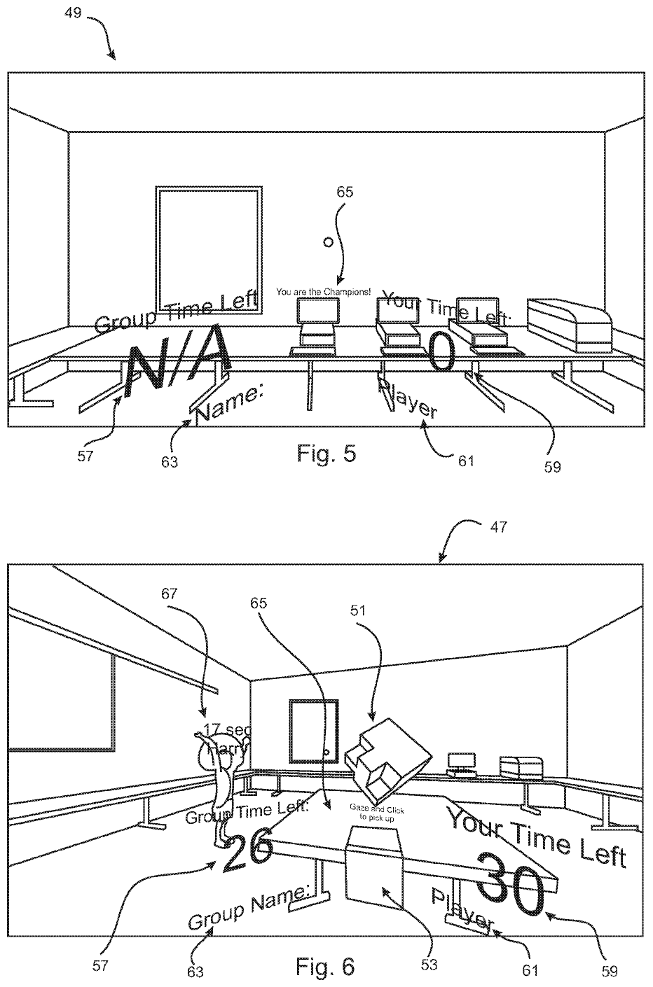

In the VR activity being run, three virtual primary areas where interactive objects of the activity can reside for teacher actor and student actor participation in the activity include a waiting room 45 as shown in FIG. 3, an activity room 47 as shown in FIGS. 4 and 6 to 8, and a podium area 49 as shown in FIG. 5.

When a student actor 43 logs in as a student object by interacting with the use case Login, an instance of the class of student is created by the VR application. This instance is associated with a position or spot in a scene, which in the activity being described in the present embodiment, is in one of the virtual primary areas, waiting room 45, activity room 47 and podium area 49.

The VR application is programmed to allow the student actor 43 to select from one of a number of model characters and adopt an avatar of the particular instance of the student, which is depicted in scenes where the student object is assigned to a spot and viewed within the first person view of another student viewing the scene. Moreover, in the present embodiment, the VR application is programmed to always present the student participating within a VR scene with a first person view, so that the student actor is able to see avatars of other students and activities, but not the avatar of them self.

In all scenes of the waiting room 45, student actors 43 participating in the activity can wait for their classmates in the waiting room 45 and see from their first person view selected avatars of the virtual objects of other student actors, after the student actors have been enrolled by interacting with the use case Login. When all student actors have enrolled, the teacher actor 41 will group them from his/her teacher terminal 29 using the teacher user interface provided by the VR application by interacting with the use case Group Students.

In all scenes of the activity room 47, all student actors in the same group play or participate within the rule restraints of the interactive content in respect of the activity. The main purpose of the activity is for the student actors to participate in a collaborative and cooperative manner within the group they have been allocated by the teacher actor to complete a designated task involving a virtual 3-D representation of a layered and/or interactive task object 51 made up of interactive component objects 53 that are components of the task object, in a competitive manner amongst themselves. The competition arises from the completion of the task being time-based, with different levels of complexity involving interactive component object selection, orientation and placement. Moreover, different interactive component objects 53 are allocated ownership status to certain student actor players, the state of which can change depending upon collaboration exercised between two student actor players over the deployment of the interactive component object 53 to fit within the interactive task object 51 at its correct location, much in the way a jigsaw puzzle may be put together. Collaboration is further enhanced by making the group perform the same task in competition with another group, which is also time-based.

As can be seen from the use case diagram, the VR application is designed so that the teacher actor 41 controls the competition by interacting with the monitoring use case and by extension the Player State List and Timer use cases, which will be described in more detail later.

In the scene of the podium area, the VR application is designed to show the results for an individual student actor on their student terminal 31 after completing an activity and retain the student object in this area to prepare for restarting the object in another activity.

Different avatars are available for actor players to select from and appear as virtual avatar objects 55 in the rooms or area of the activity. For example there may be four different avatars available for a student actor to choose from. In the present embodiment, the VR application is designed so that student actors 43 will retain their avatar after spawning.

As previously described, spawning is provided for representing virtual objects at different positions or spots in different scenes. The VR application is designed so that all student actors 43 spawn in the waiting room 45 at random positions. It is also designed so that they spawn around the interactive content of the interactive task object 51 in the activity room 47. The VR application is also designed so that students 43 in a winning group will spawn on the podium in the podium scene, while others spawn as audience around the podium. The student actors' avatar positions are synchronised to all student terminals 31 and the teacher terminal 29.

Some of the important functionalities of the VR application associated with student actor interaction with the use case Play Interactive Contents are described in more detail as follows to obtain a better understanding of how the VR application is programmed:

Rotating—the virtual head rotation of a spawned instance of a student actor is synchronized with VR gear rotation. The VR application is designed to synchronise the rotation of a student actor's head at all student terminals 31 and the teacher terminal 29.
Animations—playing animations is provided by the VR application to be undertaken by student actors to notice others. The application is designed so that a student actor can tap the touchpad to wave the hand of the avatar of their student object in the VR activity by interacting with the use case Waving in order to notice others for the purposes of, for example, transferring an interactive component object 53 of the interactive task object 51 to the avatar of another student object by interacting with the use cases Collaboration and Transferring. The application is designed so that animations will be synchronised amongst all student terminals 31 and the teacher terminal 29. The application is designed to provide functionality for another set of gestures using the touchpad to create the interaction with the use case Dancing. In this functionality the application is programmed so that when the appropriate gesturing occurs, the avatar of the student actor player performs a dance as seen by the other members of the group to similarly attract the attention of other student players in the group for performing a particular task, or just for entertainment purposes.
Collaboration—is provided by the VR application to enable a student actor player 43 to assess an interactive component object 53 picked up by them and determine whether they can correctly place it within the interactive task object 51 or collaborate with another student actor player to complete the placement of an interactive component object 53. The latter involves extension for the student actor player to interact with the Transferring use case, which will be described in more detail later. The Collaboration use case further entails the VR application effecting operation of timers for the group and individual student to create competition between participants within the group or between groups. These aspects of the use case will be described in more detail later.
Transferring—is provided as an extension of the use case Collaboration by the VR application to enable an avatar of a student player object to pass an interactive component object 53 to the avatar of another player at whom they gaze using the laser associated with the use case Gazing. In this manner the application is designed so that an actor player can transfer an interactive component object 53 to others by gazing and touching their touchpad. The recipient will thereafter own the interactive component object 53. The application is designed so that the ownership of interactive component objects 53 is synchronised.
Placing—is provided by the VR application for moving and observing an interactive component object 53. The application is designed so that a student actor player can move a grabbed object by rotating their head. They can also rotate and observe it by sweeping the touchpad. The transformation of the interactive object 53 is synchronised at all student terminals and the teacher terminal.
Grabbing—is provided by the VR application to enable a student actor to pick up an interactive component object 53 in front of his or her avatar. The application is designed so that a student actor player can grab an interactive component object 53 by invoking the use case gazing and touching the touchpad. The application is designed so that student actor players cannot interact with an interactive component object 53 if it has been picked up by another student actor.
Gazing—is provided by the VR application to trace gazing by using a laser attached a student actor player's headgear of its VR gear. The application is designed so that a student actor player can select interactive component objects 53 by gazing at them. The system is designed so that the laser of a student actor player doesn't synchronise to any of the other terminals, only the player himself can see the laser.

Each student terminal 31 is designed with a customised student user interface (UI) that shows states and messages to the student actor player 43 of the particular terminal. The UI is designed to show a group timer 57, student timer 59, player name 61, group name 63 and message 65. The message 65 usually shows actions that the actor player operating the particular student terminal 31 can do at that particular moment in time. The VR application is designed so that the UI doesn't synchronise to other terminals. Thus only the actor player himself can see the UI associated with their terminal 31.

Each student terminal 31 is designed to show a player state bar 67 within the UI, which shows the player state of one actor player to each of the other actor players participating in the activity. The avatar of each actor player has a state bar 67 on their head, which shows their time, name and score. The state bar 67 always faces to other actor observers. The information in the state bar consequently is synchronised with all of the student terminals 31 and the teacher terminal 29.

Now having regard to the functionalities of the VR application associated with teacher actor interaction of the main use cases Organise Students, Interactive Content Control and Monitoring, some of the important functionalities that are interacted with are described in more detail as follows:

Organise Students—is provided by the VR application to allow the teacher actor 41 to organise the student actors into groups and start the activity to be played by the student actors.
Group Students—is an extension of the interaction with the use case Organise Students, which is provided by the VR application for assigning actor players into different groups. The application is designed so that the teacher actor can group student actors within the waiting room 45 and assign a group name to them. The group name is synchronised to the UI on each student terminal. The GroupStudents process that is invoked for the purposes of implementing this use case, will be described in more detail later.
Interactive Content Control—is provided by the VR application to allow the teacher actor 41 to control the rotation speed of interactive content. Accordingly, the application is programmed so that the teacher actor can specifically control the rotation speed of the interactive content within the activity room 47. The rotation of the content will be synchronised to all student terminals. The InteractiveContentControl process that is invoked for the purposes of implementing this use case, will be described in more detail later.
Start—the VR application is designed so that teacher actor interaction with this use case enables the teacher actor to start the competition involving interacting with the interactive task object 51 after grouping. The teacher actor 41 can start the competition after all student actors have been allocated to groups. The application is designed so that all student actors will be teleported to their group's activity room at the teacher actor's signal.
Restart—the VR application provides for the teacher 41 to restart the game by virtue of this use case. The teacher actor can restart the game from within the podium scene 49. The application is programmed so that all data will be reset and players are teleported to the waiting room 45 for regrouping.
Monitoring—the VR application importantly provides for the teacher actor 41 to monitor the student actors involved with the activity throughout all of the scenes on a proactive and concurrent basis. In this manner, the teacher actor is able to actively supervise, and to the extent necessary, assist in teaching the student actors throughout the collaboration process. As previously mentioned, the application does this by way of allowing the teacher actor to interact with the extended use cases Roaming, Teleporting and Player State List. The Monitoring process that is invoked for the purposes of implementing this use case, will be described in more detail later.
Roaming—as an extension of interacting with the Monitoring use case, the VR application provides for the ability of the teacher actor 41 to roam within scenes by way of a virtual controller. The application is designed to display two virtual controllers 69 on the screen of each teacher terminal 29. The left one 69a controls movement, and the right one 69b controls rotation. The Roaming process that is invoked for the purposes of implementing this use case will be described in more detail later.
Teleporting—as another extension of interacting with the Monitoring use case, the VR application provides for the ability of the teacher actor 41 to switch between activity rooms 47. The teacher actor 41 can teleport a virtual object of himself/herself between different activity rooms 47 by way of this use case. The application is designed so that student terminals 31 do not synchronise with the camera of the teacher terminal 29. The Teleporting process that is invoked for the purposes of implementing this use case will be described in more detail later.
Player List State—the VR application is designed to allow a teacher actor 41 by way of extension from the Monitoring use case to show to the teacher actor a list 83 of student actor players 43 and their states by way of interacting with the Player List State use case. The list 83 shows actor player names 71, time left 73, score 75, group to which the actor player belongs 77 and IP address 79. Only the teacher terminal 29 can see the player list. The PlayerListState process that is invoked for the purposes of implementing this use case will be described in more detail later. Timer—the VR application provides countdown timers 80 for each group and each actor player by way of extension from the Player List State use case. The application is designed so that the group timer starts to count down when the teacher asserts for the competition to start. A group will lose the game if they run out of time to complete their designated activity or task. The student timer 59 only counts down when an actor player is holding an interactive component object 53. The application is further designed so that an actor player 43 can only transfer the interactive component object 53 to avatars of other actor players if he/she has ran out of time. The application is designed so that the group and actor player timers are synchronised.

The VR application is designed to define a number of different object states and interactions not specifically shown in the use case diagram of FIG. 2, but which are important for the purposes of actor players completing collaborating in the activity. These are described as follows:

Grabbable Object—this defines the state of an interactive component object 53 when it can be picked up by the avatar of a student actor player 43. The actor player 43 who picks up the object can move, transfer or place it within a corresponding slot of the interactive task object 51. The movement of the interactive component object 53 is synchronised to all terminals. For example an interactive component object 53 may be in the form of a small cube and is in a grabbable object state for a particular actor player for the duration that it has not yet been correctly fitted into the interactive task object 51.
Server Hold Object—this defines the state of an interactive component object 53 when it cannot be picked up by the avatars of actor players 43. The application is designed to synchronise the state to all terminals. The teacher terminal 29 maintains the state of these objects. For example, the interactive task object 51 in the present embodiment is in the form of a rotating puzzle which is defined as a server hold object within the VR application.
Approaching Checking—this defines the state of a grabbable object when it is approaching the nearest slot on the server hold object or when passed to the avatar of another player, to facilitate it being placed into the slot or being received by the other player. All movement will be synchronised to all student terminals.
Drop object—this defines the state of a grabbable object when it is placed in a slot. When a grabbable object is placed into a slot by approaching checking, the actor player controlling the avatar object can tap the touchpad to drop it. The slot will hold the grabbable object after this action.
Position Checking—this defines the state of a grabbable object when it is dropped in a correct slot. The application is designed to turn an indicator green when it has been correctly dropped, otherwise it will turn the indicator red. The Indicator is synchronised.
Grabbable Object Spawning—this defines the state of a grabbable object when it is spawned to the next object from where the previous one was placed. New grabbable objects are spawned by the teacher terminal 29 and synchronised to student terminals 31.

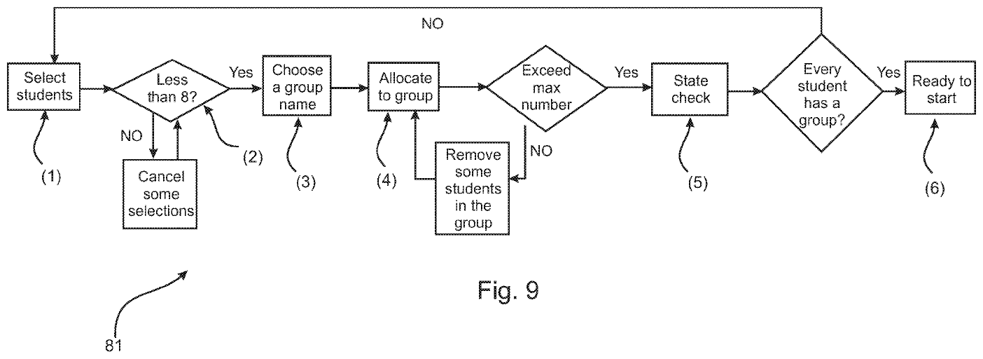

Now describing the specific processes previously mentioned that are invoked by the VR application to allow the teacher to interact with the student actors and the activity, regard is had to FIGS. 9 to 15.

A flow chart of the GroupStudents process 81 is shown in FIG. 9 and essentially involves the teacher actor 41 performing the following steps:
(1) Enter into the Organise Students display of the waiting room 47 and check the student list 83, which is displayed on the top right corner of the screen; and wait until all student actors have logged in, which is indicated by the student actor's name appearing in the list 83.
(2) Select no more than 8 student actors to become members of a group by checking checkboxes in front of their name from the displayed list 83.
(3) Choose a group name in the drop-down box 85 provided on the top left corner of the waiting room scene 47.
(4) Press ‘Group Select’ button to allocate selected student actors to the group.
(5) Check all student actor states after allocation to see if everyone is in a group.
(6) Press the ‘Start’ button when the teacher 41 is ready to commence the activity.

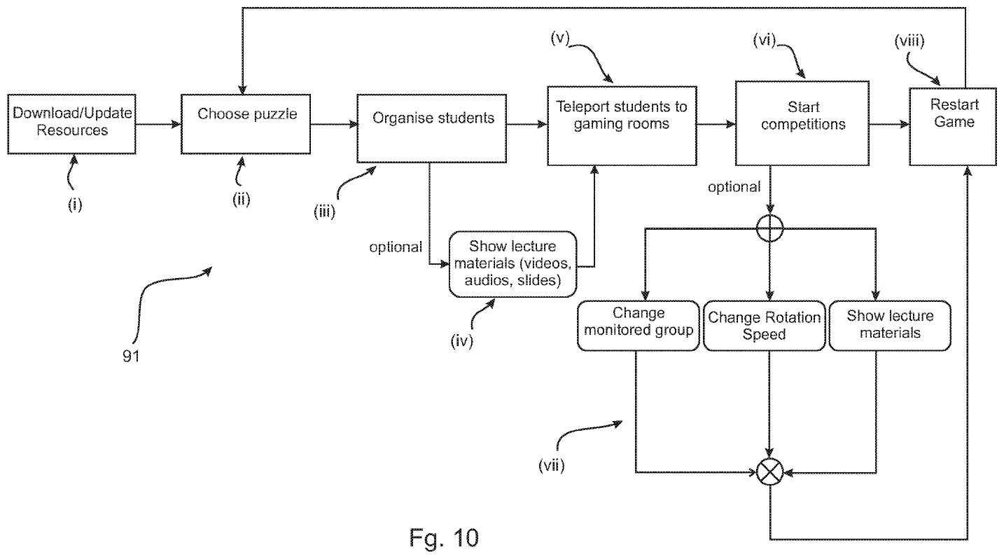

A flow chart of the InteractiveContentControl process 91 is shown in FIG. 10 and essentially involves the teacher actor 41 performing the following steps:
(i) Download a new educational resource, or updating a previously downloaded resource.
(ii) Choose an activity, which in the present embodiment is a puzzle involving collaborative skills to be performed by the student actors in order to complete it.
(iii) Organise the student actors into groups, invoking the Organise Students use case.
(iv) Other educational resources involving non-VR content can be optionally invoked for teaching purposes at this time, before undertaking the play activity involving the VR content.
(v) Teleport avatars of student actors to activity rooms for commencement of the interactive content.
(vi) Start competitions in respect of the selected activities to be participated in by the student actors.
(vii) Various control functions can be performed during this time such as changing models and groups, changing the rotation speed and showing relevant educational resources involving non-VR content.
(viii) Restart the game activity after it has been completed.

The Monitoring process simply provides the teacher user interface for the teacher actor 41 to monitor student actors 43, groups of student actors and game VR activity states invoking the Roaming, Teleporting and the PlayerStateList processes, which will now be described in further detail.

In the case of the Roaming process, as previously mention, the VR application invokes the teacher user interface for the teacher actor 41 to display two virtual controllers 69 in each of the scenes. The Roaming process is programmed so that the teacher actor can perform the following steps:
(1) Put thumb on the small circle.
(2) Drag the small circle to the direction where the teacher object in the scene wishes to move or rotate.
(3) The movement/rotation speed depends on the distance between the centre of the small circle and the centre of the larger circle.
(4) The small circle will go back to its original position after being released.

As shown in FIG. 11, progressive states of a virtual controller 69 from left to right indicate idle 93, slow 95, intermediate 97 and fast 99 speeds.

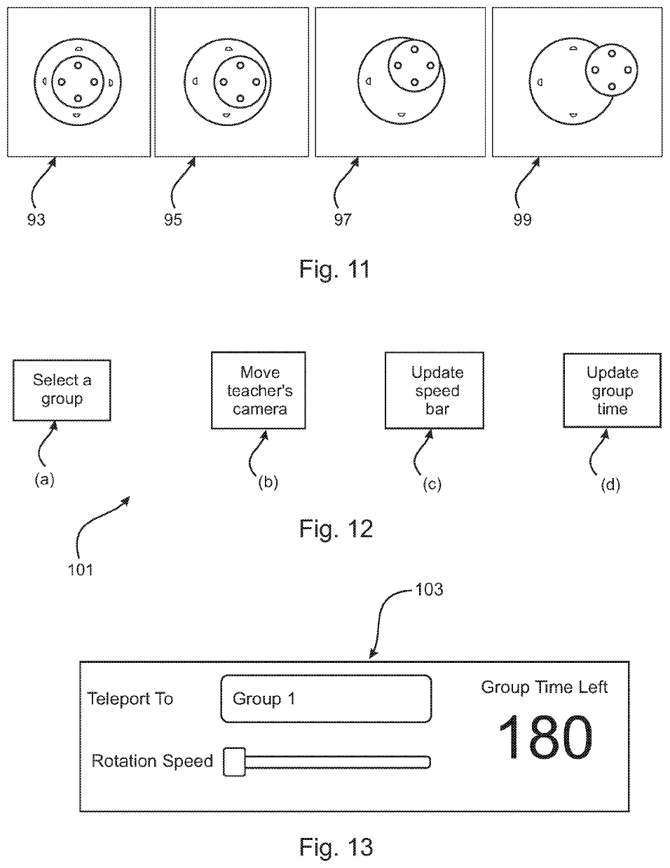

In the case of the Teleporting process 101, the VR application is programmed to allow the teacher actor 41 to perform the following basic steps, as shown in FIGS. 12 and 13:
(a) Select a group in the dropbox 103, which is displayed on the top left of each screen by the teacher user interface.
(b) Move or teleport the teacher actor's first person or camera view to a selected group.
(c) Update the ‘Rotation Speed’ bar to the state of the current group, which is done automatically.
(d) Display the time under the ‘Group Time Left’ in the top middle of the screen, which will automatically show the time left for the current group to complete the activity.
(e) Place the teacher actor's camera view to a predefined position in the destination activity room after teleporting.

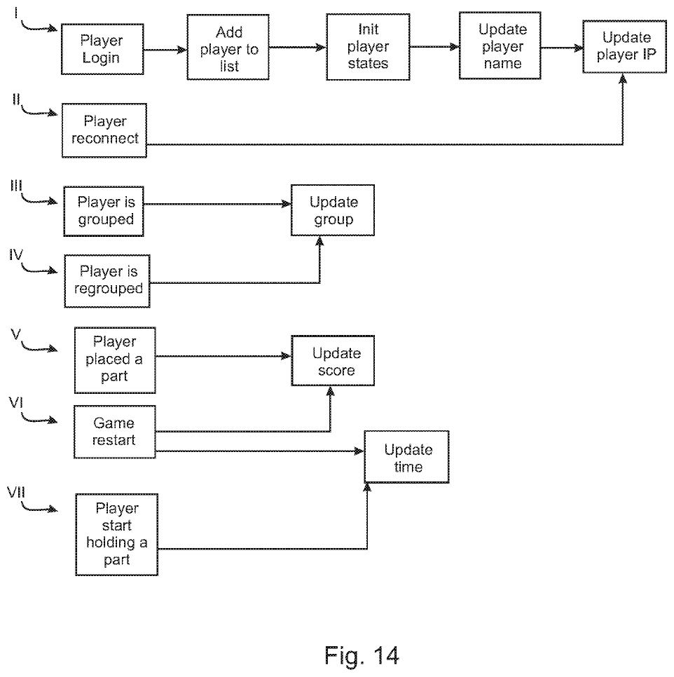

A flow chart of the steps performed by the PlayerStateList process 105 is shown in FIG. 14 for each of actor player steps that can be performed, whereby:
I. When an actor player logs in, they are added to the player list, in their state is initialised, the actor player name updated and the player IP address updated.
II. When an actor player reconnects, their IP address is updated.
III. When an actor player is grouped, their group is updated.
IV. When an actor player is regrouped, their group is updated.
V. When an actor player correctly places an interactive object or part, their score is updated.
VI. When a game is restarted, the actor player's score is updated and the time is updated.
VII. When an actor player starts to hold an interactive object or part, their time is updated.

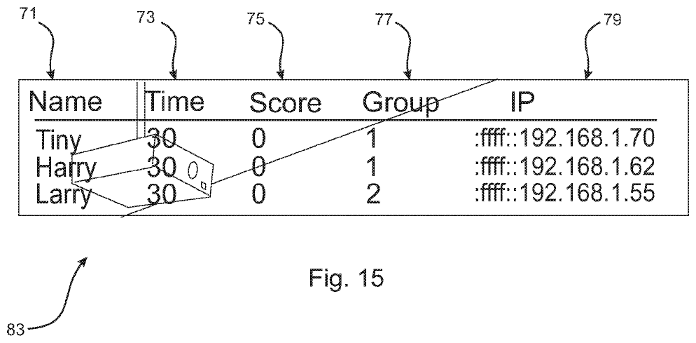

As shown in FIG. 15, the player state list 83 as previously described with respect to the Player State use case and as displayed on the various teacher scenes, is shown in more detail.

An important aspect of the present embodiment is the ability of the VR platform to teach spatial configuration and conceptual alignment skills as well as communication and collaboration skills in a competitive VR environment in a controlled and supervised manner that is both educational and entertaining to the student. The Collaboration use case is important in achieving these effects. The Collaboration use case essentially entails:
(1) Students doing their best to correctly place a parked constituting an interactive component object 53 within the puzzle constituting the interactive task object 51 with a view to finish the puzzle—this is a test of their knowledge.
(2) Enforcing a student actor 43 holding a part to assess the part and make a decision as to whether they are the best one to correctly place that part within the puzzle or whether they need to collaborate with another student actor to place the part within the puzzle—thus if the student actor cannot reach or see the empty slot into which the part is required to be placed, despite knowing how to place the part, they nonetheless need to pass the part to another, enforcing practice of team work and collaboration.
(3) The provision of a group timer that counts down from a start time to 0 so that if the group fail to complete correct placement of all the interactive component objects within the puzzle, the group will fail—the students have to make quick and correct decision is about the next step they will take, which is a practice of fast decision making.
(4) The provision of a student timer for each student where the timer is set to an extremely short period to avoid one student monopolising the task to the detriment of other students—so even the slowest team member is required to participate and be helped by collaboration from other students.

The design of the VR application for implementing the Collaboration use case is best described having regard to the different states and transitions for the student, student timer and group timer objects.

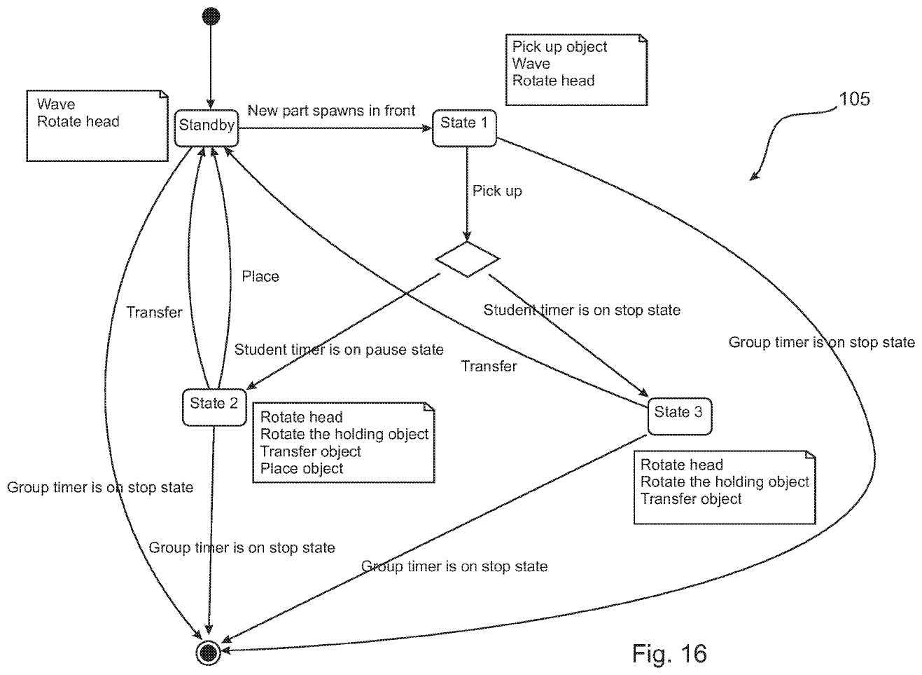

As shown in FIG. 16, the Student State diagram 105 for the student object comprises four states, namely Standby, State 1, State 2 and State 3. The Standby state is transitioned to from the initial state, from where the VR application transitions to State 1 by the student rotating their head to spawn a new part in front of them functioning as an interactive component object 53, or to the final state when the group timer 57 has reached the ‘Stop’ state as shown within the Student Timer State diagram 107. The Animation use case can also be invoked at this time to interact with the Waving case use.

The State 1 state transitions to either a choice pseudo-state by the student picking up the object or to the final state when the group timer 57 has reached the ‘Stop’ state. The choice pseudo-state transitions to State 2 or State 3 dependent upon whether the student timer 59 is on the Pause state or the Stop state as shown in the Student Timer State diagram 107.

From the State 2 state the VR application transitions to the Standby state by the student actor 43 either invoking the Transferring or the Placing use cases, or to the finish state by the group timer 57 reaching the ‘Stop’ state as shown in the Student Timer State diagram 107.

From the State 3 state the VR application transitions to the Standby state by the student actor 43 invoking the Transferring use case or to the finish state by the group timer 57 reaching the ‘Stop’ state as previously described.

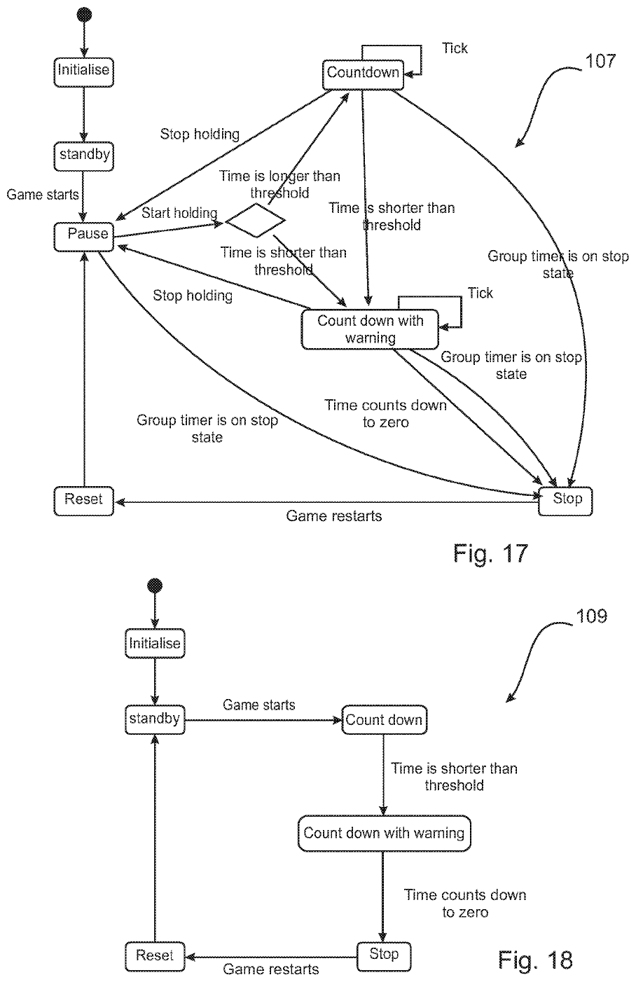

As shown in FIG. 17, the Student Timer State diagram 107 for the student timer object comprises seven states, namely Initialise, Standby, Pause, ‘Count down’, ‘Count down with warning’, Stop and Reset. The Initialise state is transitioned to from the initial state, from which the VR application transitions to the Standby state to wait for the game to start by the teacher actor 41 invoking the Start Game or Restart Game use cases. The VR application then transitions to the Pause state once the game starts.

The Pause state transitions to a choice pseudo-state in response to a student actor starting to hold an interactive component object 53 spawned in front of them by invoking the Grabbing case use, which then transitions to either the ‘Count down’ state or the ‘Count down with warning’ state, depending upon whether the student timer 59 is greater than a threshold time or shorter than a threshold time. Otherwise, the Pause State transitions to the Stop state when the group timer 57 has timed out.

The ‘Count down’ state is self-transitioning whilst the student timer 57 is counting down and transitions to either the Pause state when the student actor has stopped holding the object or the ‘Count down with warning’ state when the student timer is less than the threshold time. Alternatively, it transitions to the Stop state when the group timer 57 times out.

The ‘Count down with warning’ state is also self-transitioning whilst the student timer 57 is counting down and transitions to either the Pause state when the student actor has stopped holding the object or the Stop state when either the student timer times out by counting down to zero, or when the group timer 59 times out.

The Stop state transitions to the Reset state when the teacher actor 41 decides to restart the game, and the VR application transitions from the Reset state to the Pause state when the game actually starts.

As shown in FIG. 18, the Group Timer State diagram 109 for the group timer object comprises six states, namely Initialise, Standby, ‘Count down’, ‘Count down with warning’, Stop and Reset. The Initialise state is transitioned to from the initial state, from which the VR application transitions to the Standby state to wait for the game to start, as in the case of the Student Timer State diagram 107.

The VR application then transitions to the ‘Count down’ state, where it self-transitions whilst the group timer 57 counts down to a threshold time. When the threshold time is reached, the VR application transitions to the ‘Count down with warning’ state, which in turn self-transitions until the group timer 57 times out by counting down to zero.

When the group timer 57 times out the VR application transitions to the Stop state. The VR application then transitions to the Reset state upon the teacher actor 41 restarting the game, from which the application transitions to the Standby state upon the game starting.

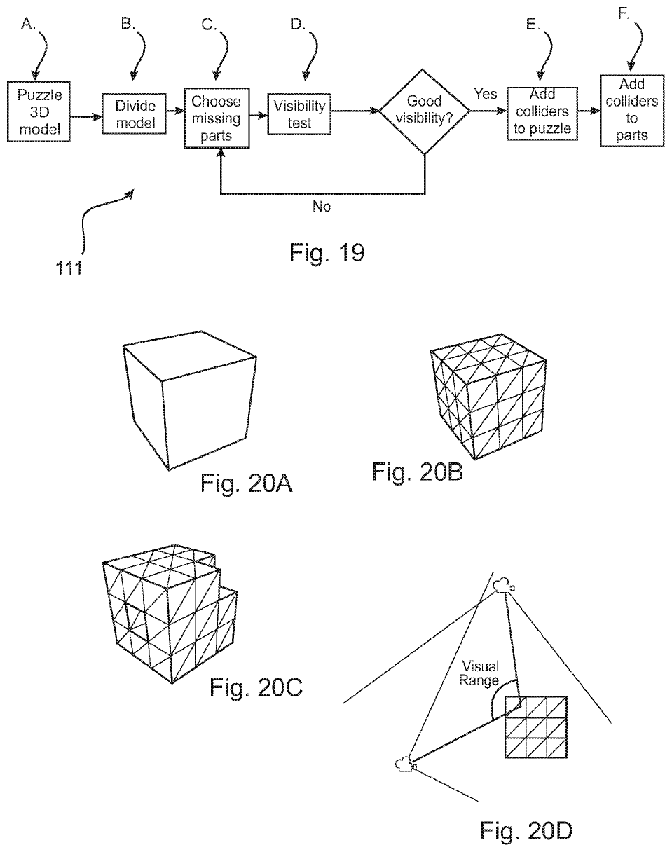

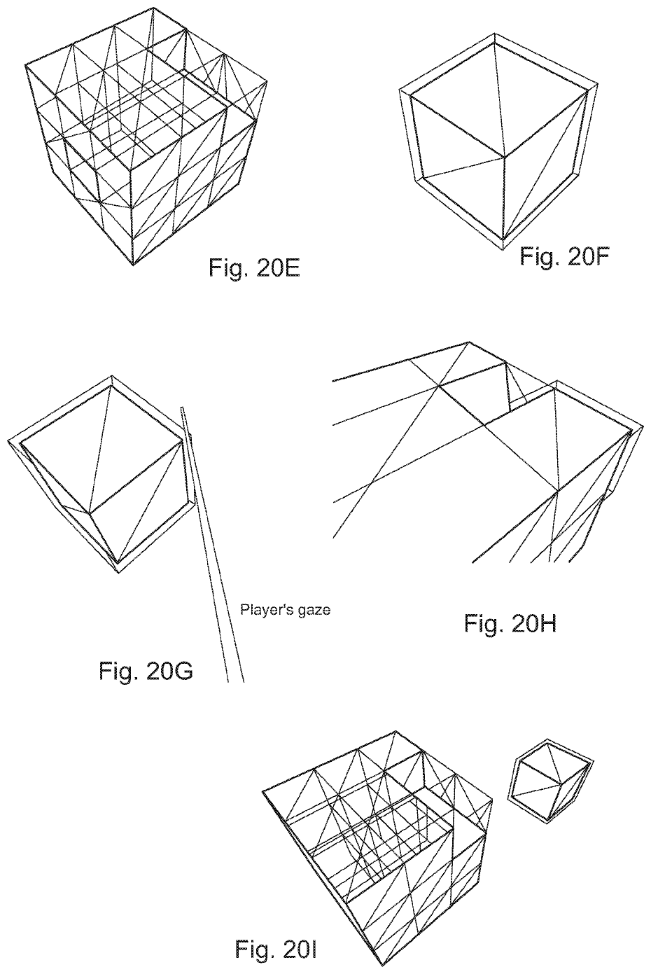

It needs to be appreciated that another important aspect of the present embodiment is the provision of the interactive task object 51. An example of a puzzle suited to function as an interactive task object in a game VR activity for teaching collaborative skills using the VR application of the present embodiment will now be described with reference to FIGS. 19 and 20.

A design process for designing an interactive task object is synthesised by a DesignActivity process 111. The DesignActivity process enables puzzles to be designed that promote the use of collaborative skills of student actors participating in the activity. The algorithm for designing such a puzzle follows a prescribed set of steps performed by a series of functions as shown in the flow chart of FIG. 16. The steps and functions will now be described with reference to the virtual diagrams of the model shown in FIGS. 20A to 20I, wherein:
A. Make proposed puzzle model. This is synthesised by an object model function that creates a virtual task model of an interactive task object—FIG. 20A.
B. Divide the model so that it is easier to decide which part can be taken down. This is synthesised by a model division function that divides the virtual task model into virtual component models of interactive component objects—FIG. 20B.
C. Take down some parts from the puzzle. This is synthesised by a model component removal function that enables selected virtual component models to be removed from the virtual task model, leaving one or more empty slot is in the virtual task model—FIG. 20C.
D. Take visual test. Make sure that the visual range of the empty slot is more than 90° and less than 180°, so that not all of the students can see the slot at the one time. This is synthesised by a visual testing function that enables visual inspection of the virtual task model to determine whether the visual range of an empty slot is within a prescribed viewing range from one during perspective of the virtual task model. It further enables visual inspection of the virtual task model to determine that the configuration of the empty slot cannot be seen from one or more alternative viewing perspectives from around the virtual task model—FIG. 20D.
E. Add colliders to the empty slot. The collider should be the same size as the missing parts (the empty spaces within the cube framed by the wires). The collider can detect a player's gaze and trigger events for further logic after collision. This is synthesised by a collider adding function that enables a collider to be added to an empty slot, where the collider is substantially the same size as the remove virtual component model that fits the empty slot.—FIG. 20E.
F. Add a collider to the part taken down. The collider should be bigger than the part (10% bigger), so that the part is wrapped by the collider. This is synthesised by the collider adding function enabling a collider to be added to a removed virtual component, so that the collider is bigger than, and envelops, the remove virtual component model.—FIG. 20F.

This design process allows for an interactive component object part to be easily selected by an actor player when his or her gaze approaches the part—FIG. 20G. When an actor player wants to pick up the part from the puzzle, the bigger collider on the removed interactive component object part can detect the gaze earlier than the collider on the puzzle. In this case, the picking up logic on the part rather than the placing object logic on the puzzle, will be executed—FIG. 20H and FIG. 20I.

A limitation of the VR platform structure of the first embodiment is that the software programming of the various items describing the virtual worlds and the logic and control operations, networking functionalities and content management services are largely integrated or mixed in the VR application. This tends to work against the VR system being device agnostic and limits the scalability of the system and the deployment of interactive content to different applications beyond the education environment described, and different schools within the education environment itself.

These limitations are overcome by adopting an alternative VR platform content structure, which will now be described in the second specific embodiment of the best mode for carrying out the invention.

For the purposes of comparison, the second specific embodiment is still directed towards a computer network system including a VR platform that is cloud based and services that are connected via the Internet to individual school network systems for deploying logic and control operations, content and content management services. However, instead of the software being largely integrated within a VR application, a more clustered system is adopted with multiple servers and the software divided into discrete parts.

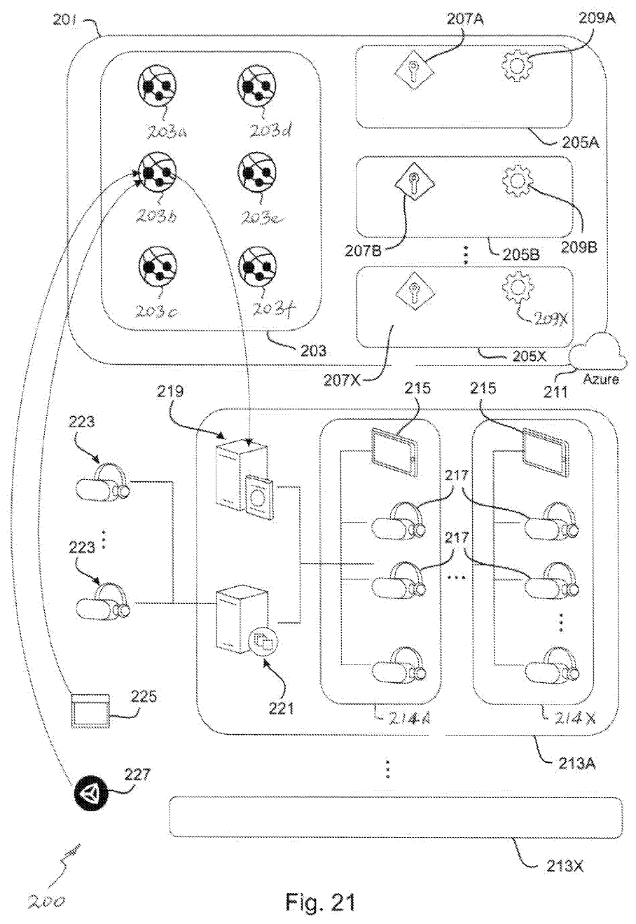

As shown in FIG. 21, the VR platform is provided by a VR system 200 that is divided into three parts according to the deployment location. These parts comprise cloud based applications 201, local applications 213A to 213X, and tools comprising a creator toolkit 225 and a content design Unity™ plugin 227. Each part has several subsystems and components as shown.

In the case of the cloud based applications 201 six server subsystems 203 are deployed on a cloud computing service, particularly designed for building, testing, deploying and managing applications and services through a global network of data centres. In the present embodiment, Microsoft Azure™ is used as software as a service, platform as a service and infrastructure as a service to provide the cloud computing service.

Consequently, each school or organisation 205A to 205X can conveniently have its own active directory provided by Azure AD™ in the cloud 211, which maintains their access control service 207A to 207X and mobile device management (MDM) system 209A to 209X using Microsoft Intune™.

The six server subsystems 203 comprise a login server 203a, a content management system 203b, a resource building server 203c, a user data server 203d, a service provider website 203e and a log server 203f.

The login server 203a is a federation to the active directory of all schools participating in the VR system 200, which can verify access requests with tokens assigned by each school's access control service 207A to 207X. The login server 203a provides access rights to the rest of the cloud servers 203 according to the token sent with the request.

The user data server 203d maintains the personalised data of all users of the VR system 200, including name, avatar, cache server IP address, control server IP address et cetera. Within a classroom group 214A to 214X, devices comprising a teacher's terminal 215 and student terminals 217 send requests to the user data server 203d to get their personalised information after being verified by the login server 203a.

The content management system (CMS) 203b maintains all educational resources and customised packages for the classroom 214. In the present embodiment, the CMS 203b is a web application developed by ASP.NET™. A teacher actor can access the CMS 203b by way of any popular web browser. The teacher actor can customise their classroom package and save it under their personal list, then download and push it to the devices of all student actors before a VR educational session.

The CMS system 203b also maintains the web services of downloading, uploading and updating customised materials. Users can upload and share contents created with the creator toolkit 225 and content design Unity™ plugin 227.

The service provider website 203e is a public website for introducing the platform, announcing news and promoting new contents. It also operates as a portal to the CMS 203b.

The resource building server 203c is transparent to end users. It is limited by the Unity™ asset bundle, whereby all contents need to be exported from the same Unity™ version used by the teacher terminal 215 and student terminals 217. It builds all customised content uploaded by users with the current version of Unity™ used by the platform. It also rebuilds all existing content on the CMS 203b when there is an upgrade of the Unity3d™ version of the VR platform.

The log server 203f receives scheduled state reports and crash reports from all components of the entire VR platform.

Each school has their own Azure AD™ active directory 207, which maintains the access control service for their teachers and students. There is also a MDM system 209 in the Azure AD™ advisory directory 207 for each school 205, which is designed for installing and updating the student and teacher terminal applications.

The local applications 213 comprise four subsystems deployed in the local network of each participating school or organization 213. These subsystems comprise a cache server 219, a control server 221 and the teacher terminal 215 and student terminal 217 devices.

The control server 221 maintains network connections with one or several classrooms 214A to 214X, specifically providing logic and control operations for each group or classroom 214 comprising teachers in the form of super actors and students in the form of user actors. These logic and control operations include providing network functionalities between devices of the actors, namely the teacher terminals 215 and student terminals 217, and other devices associated with the VR platform.

The teacher terminal 215 and student terminal 217 in one classroom 214 can be synchronised in a session running on the control server 221. Also, the remote subsystem servers 203 can connect to the control server 221 and be synchronised to the teacher terminal 215 and other student terminals 217.

As described in the first embodiment, this synchronisation is achieved through networking properties associated with interactive content providing synchronisation states on a substantially continuous basis to enable the interactive content to be synchronised amongst the various devices.

Consequently, this synchronisation allows engagement of user actors with more complex interactive content and collaboration involving the same with other user actors. Thus, interactive content in the form of an interactive object comprising interactive segments can be created. In this instance, each avatar, interactive object and interactive segment individually includes networking properties to substantially continuously issue synchronisation states thereof. This synchronisation enables avatars to perform various functionalities such as grabbing, passing and placing on the interactive object and interactive segments thereof.

The teacher terminal 215 in the present embodiment is implemented on a tablet. The teacher actor can fully control the progress of a lecture or lesson in a VR environment via the teacher terminal 215. Importantly, the teacher terminal 215 can monitor the entire class within the VR environment itself. It can also push selected content to all student terminals 217 in the classroom 214.

The student terminal 217, as in the preceding embodiment, runs on Samsung GearVR using VR headsets with S8 smart phones. Student actors can customize their avatar and personal information before login. After connecting to the control server 221 and verification by the login server 203a in the cloud 211, student actors can see their classmates and use the touchpad on their VR headsets 217 to collaborate and interact with each other within the VR environment.

The cache server 219 is in direct communication with the CMS 203b to provide content management services directly to the super actor and user actors within a group or classroom and the particular content associated with that group or classroom.

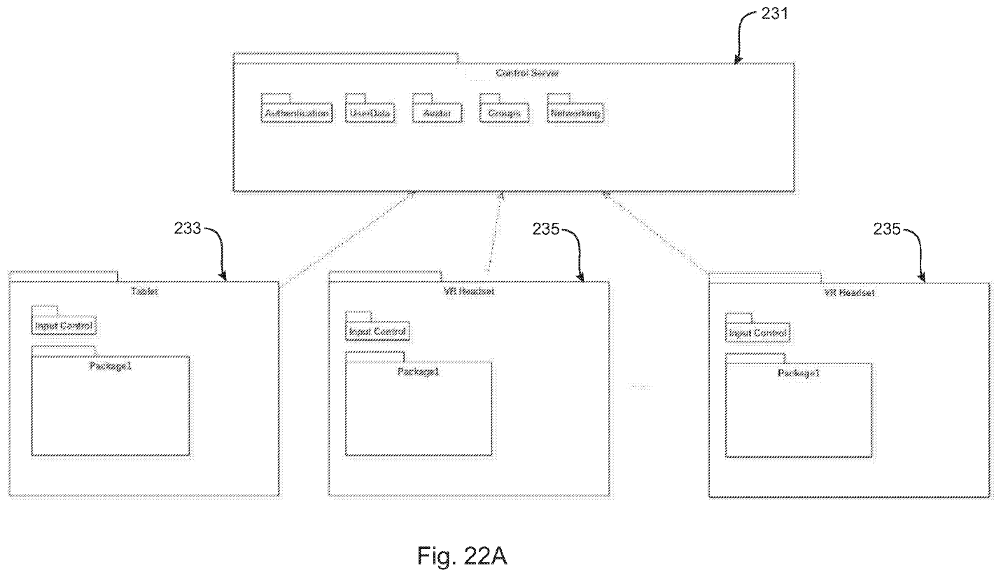

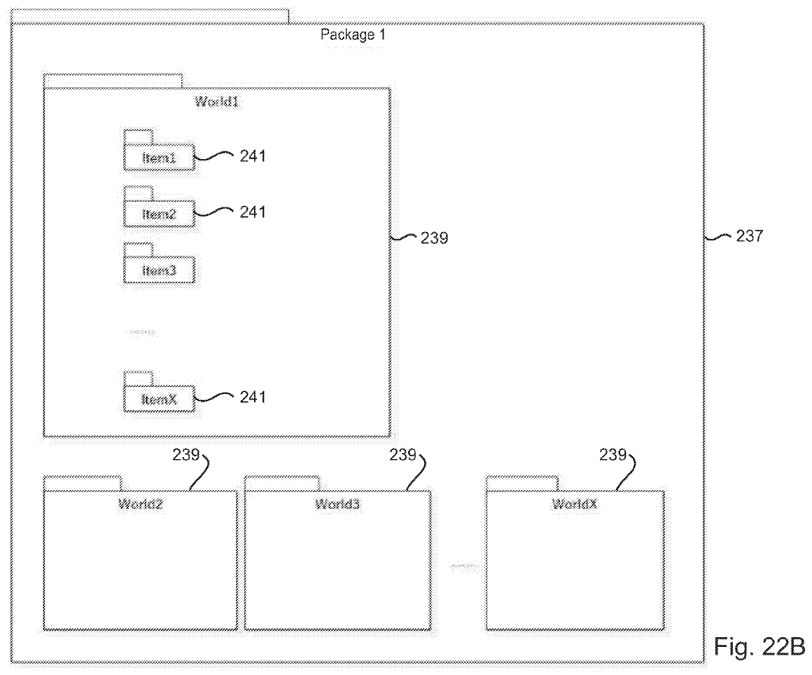

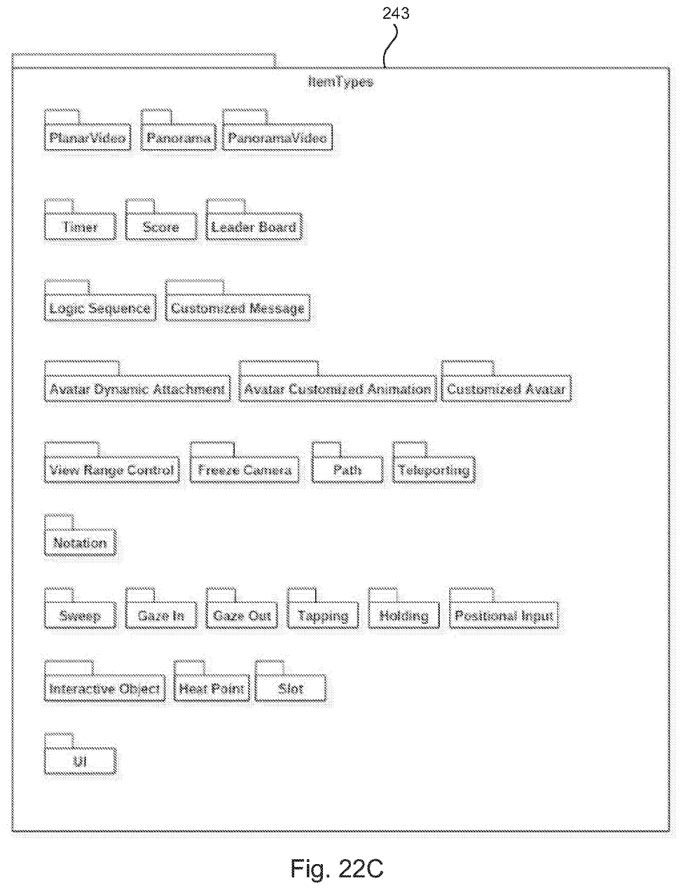

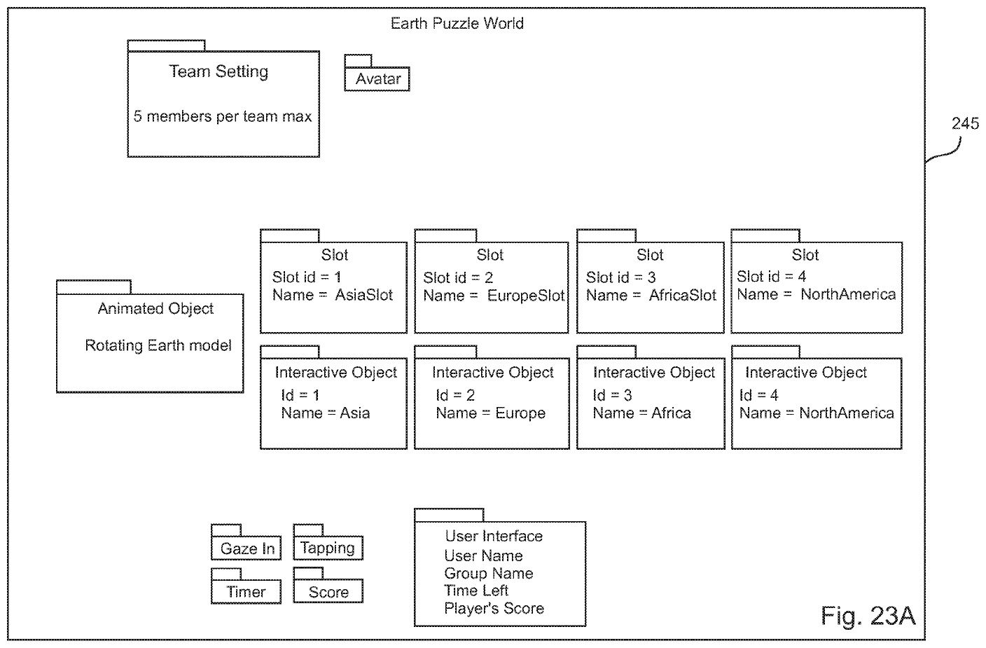

As shown in FIG. 22A, the control server 221 is specifically structured to provide discrete processes for Authentication, UserData, Avatar, Groups and Networking. The tablet 233 for the teacher terminal 215 and the VR headsets 235 for the student terminals 217 are each structured to provide for Input Control and a package 237.

The package 237, as shown in FIG. 22B comprises data technically describing one or more discrete virtual worlds 239 customised according to the particular device and the selected content. The data associated with each virtual world 239 comprises a prescribed array of items 241 corresponding to different item types 243 which are shown in more detail in FIG. 22C. Each virtual world 239 is customised with selected items 241 to provide prescribed functionality to the particular actor and to the particular content to be associated with the particular virtual world.

In the case of the VR headset 235, the item types 243 are characterised to create a virtual world 239 that is capable of providing interaction and collaboration between:
(i) a plurality of user actors by virtue of their devices;
(ii) user actors and interactive content; and
(iii) super actors and user actors by virtue of their devices.

To achieve the minimum functionality associated with a virtual world 239, the item types essentially include:
A. networking properties associated with interactive content providing synchronisation states substantially continuously, in order to enable the interactive content to be synchronised amongst the devices;
B. group settings for the virtual world; and
C. a user interface (UI) for the devices to enable the devices to control the virtual world and trigger functionalities therein or associated therewith.

As shown in FIG. 22C, the item types 243 available for item 241 selection within a virtual world 239 further include:
(a) video including planar video, panorama or panorama video, or any combination of these;
(b) timing, scoring or player list, or any combination of these;
(c) logic sequencing or customised messaging, or any combination of these;
(d) avatar assets including avatar dynamic attachment, avatar customised animation or customised avatar, or any combination of these;
(e) movement including view range control, freeze camera, path or teleporting, or any combination of these;
(f) notation;
(g) positioning, including sweep, gaze in, gaze out, tapping, holding or positional input, or any combination of these;
(h) object interaction including Interactive object, heat point or slot, or any combination of these.

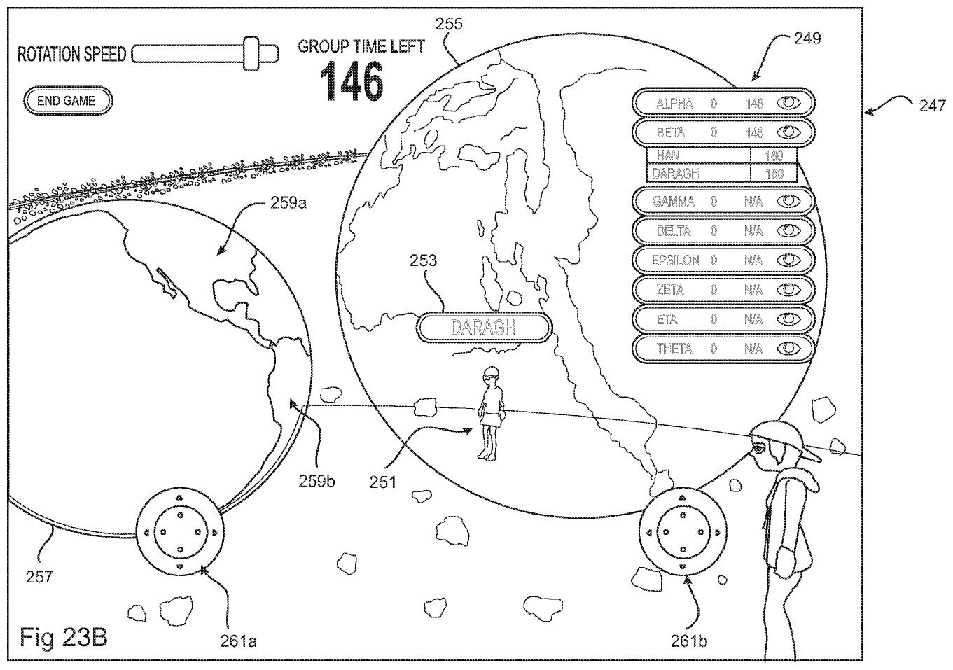

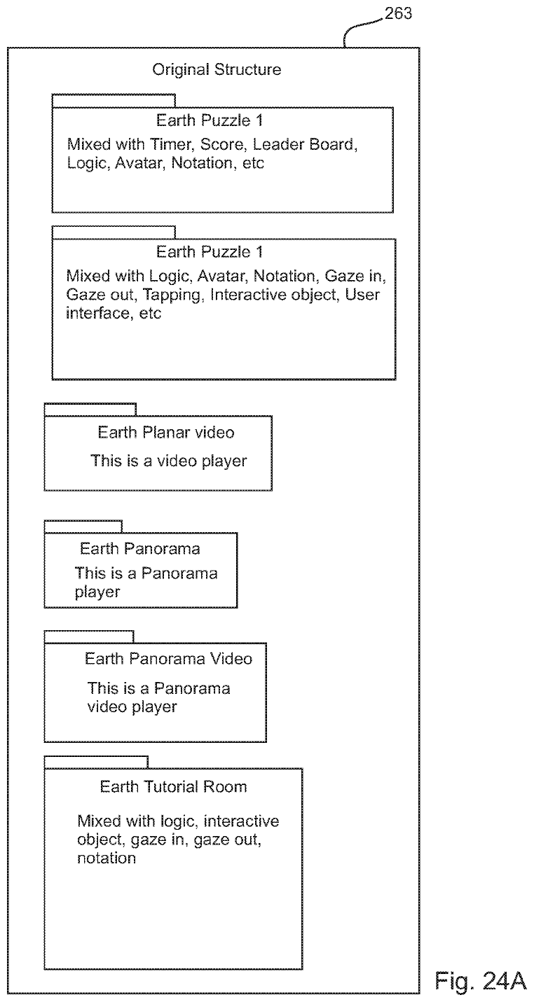

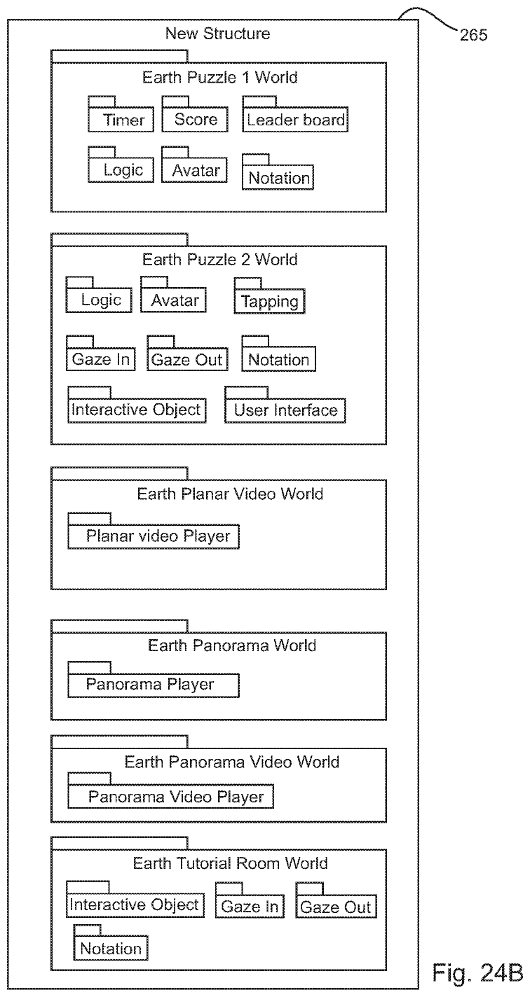

An example of a virtual world 239 created using item types is shown in FIG. 23A. This virtual world 245 describes an interactive object entitled Earth Puzzle and includes the essential item types 243:
(i) Team Setting which provides the group settings for the virtual world and contains the name and capacity of each team;
(ii) Avatar specifying the avatar item type;
(iii) Slot and Interactive Object, where if the slot id=interactive object id, the interactive object can be placed into the slot—in the diagram, the AsiaSlot corresponds to the Asia interactive object, and in the screen shot, the Africa continent (interactive object) is in front of the boy (avatar) and semi-transparent continent (slots) are on the rotating earth; and
(iv) User Interface, where the slider bar on top left, the drop down menu on top right are UI for the teacher terminal.

Both the Avatar and Slot and Interactive Object include the networking properties previously described.

Other item types 243 include:
(i) Animated Object, being an item type which is a 3D object with animation—in this scenario, the rotating earth is the animated object;
(ii) Timer, where the hour glass on the earth is the timer;
(iii) Score, where the score is shown in the drop down menu; and
(iv) Gaze in and Tapping, which are actions that the user can do using their VR headset.

The virtual world 239 is effectively displayed as shown in FIG. 23B including scores and player names as shown in the player list 249, an Avatar 251 of the player named Daragh 253, the interactive object 255 being a 3D representation of the world showing the continents Asia, Europe, Africa and North America. An animated object 257 in the form of a rotating earth model is included, which in the display shows the continents of North America 259a and South America 259b. Spatial position is provided by the virtual controllers 69a and 69b on the screen of each teacher terminal, in a similar manner as described in the first embodiment. and timing at the top left.

The intention of the game is for a user actor to locate and grab interactive segments, being continents, of the interactive object 255, and place these into corresponding slots provided in the animated object 257 that provide the correct position of a selected continent in the rotating earth model.

A comparison of the different structures adopted for describing the earth puzzle in accordance with the first embodiment is shown at 263 in FIG. 24A, and in accordance with the second embodiment is shown at 265 in FIG. 24B. As can be seen, the different items 241 are mixed with the logic and items of different item types in the original structure 263 of the first embodiment, whereas these are discretely separated out in the new structure 265 of the second embodiment. The division of the items according to the new structure enhances the agnostic characteristics of the VR system making it simpler and quicker to adapt to different device types and applications.

In another specific embodiment that way also function as the best mode for carrying out the invention, the interactions mentioned in the preceding embodiments that involved a student actor physically engaging the VR gear, such as tapping on the side of the trackpad, are dispensed with and alternative interactions that are specific VR gear agnostic are used. Such an arrangement allows the VR application to be run on different clients such as HTC VIVE headsets, Samsung gear, Microsoft gear et cetera.

From the foregoing, it should be evident that various embodiments can be devised using different combinations of interactions, puzzles and interactive task objects, to achieve the intended purpose of the invention. Therefore, it should be appreciated that the scope of the invention is not limited to the scope of the specific embodiments described.

Modifications and variations as would be apparent to a skilled addressee are deemed to be within the scope of the present invention.

1. A virtual reality (VR) system for providing engagement of a super actor with a plurality of user actors and enabling interaction and collaboration between the user actors in association with interactive content including avatars of the user actors in a VR environment, the VR system comprising:
a processing system to provide:
(a) logic and control operations of one or more groups of super actors and user actors, and networking functionalities between devices of the super actors and user actors and other devices associated with the VR system; and
(b) content management services directly to the super actor and user actors within a group and the particular interactive content associated with the group;
the device of the super actor comprising a monitor including an intelligent processor, and the devices of the user actors each comprising a VR headset including an intelligent processor;
each of the devices being configurable to activate a package comprising data technically describing one or more discrete virtual worlds, the data comprising a prescribed array of items corresponding to different item types, each virtual world being customised with items to provide prescribed functionality to the particular actor and to the particular content to be associated with the particular virtual world;
wherein the item types are characterised within the VR headset to create a virtual world capable of providing interaction and collaboration between:
(i) a plurality of user actors;
(ii) user actors and interactive content; and
(iii) super actors and user actors;
by including:
A. networking properties associated with interactive content providing synchronisation states substantially continuously to enable the interactive content to be synchronised amongst the devices;
B. group settings for the virtual world; and
C. a user interface for the devices to enable the devices to control the virtual world and trigger functionalities therein or associated therewith.

2. A VR system as claimed in claim 1, wherein the interactive content includes an interactive object comprising interactive segments, whereby each avatar, interactive object and interactive segment individually includes networking properties to substantially continuously issue synchronisation states thereof.

3. A VR system as claimed in claim 1 or 2, wherein the item types further include any one or more of the following:
(a) video including planar video, panorama or panorama video, or any combination of these;
(b) timing, scoring or player list, or any combination of these;
(c) logic sequencing or customised messaging, or any combination of these;
(d) avatar assets including avatar dynamic attachment, avatar customised animation or customised avatar, or any combination of these;
(e) movement including view range control, freeze camera, path or teleporting, or any combination of these;
(f) notation;
(g) positioning, including sweep, gaze in, gaze out, tapping, holding or positional input, or any combination of these;
(h) object interaction including Interactive object, heat point or slot, or any combination of these.

4. A VR platform including a VR application having a plurality of processes to enable the performance of a plurality of use cases enabling interaction between:
(i) a teacher actor, (ii) a student actor, and (iii) spawned instances of the teacher actor and student actor and a plurality of interactive objects all forming part of a VR activity in a virtual environment using tools of a software development toolkit to perform VR functionalities;
a plurality of teacher use cases to allow a teacher actor to interact with a VR application to:
(a) organise a plurality of student actors to interact with an interactive task object and each other for teaching and learning collaboration and interactive skills in a collaborative and competitive manner, whereby the interactive task object is defined within a VR activity and comprises a plurality of interactive component objects;
(b) control interaction associated with the VR activity and the competitive participation of student actors; and
(c) monitor the competitive participation of student actors associated with the VR activity; and
a plurality of student use cases to allow a student actor to interact with the VR application to participate in the VR activity including interacting to:
(i) gaze at an interactive object within the VR activity as a means of selecting the interactive object;
(ii) grab an interactive object within the VR activity as a means of holding the interactive object;
(iii) place a grabbed interactive object within the VR activity as a means of moving the interactive object;
rotate the head of a spawned instance of a student actor within the VR activity as a means of changing the view of the student actor within the virtual environment.

5. A virtual reality (VR) application for a VR platform for teaching and learning involving interaction between a teacher actor and a plurality of student actors, the VR application comprising:
a plurality of processes to enable the performance of a plurality of use cases enabling interaction between: (i) a teacher actor, (ii) a student actor, and (iii) spawned instances of the teacher actor and student actor and a plurality of interactive objects all forming part of a VR activity in a virtual environment using tools of a software development toolkit to perform a set of VR functionalites;
wherein one of the processes is a design process for designing an interactive task object comprising interactive component objects for use in the virtual environment, the design process including:
an object model function for creating a virtual task model of an interactive task object;
a model division function for dividing the virtual task model into virtual component models of interactive component objects;
a model component removal function to remove selected virtual component models from the virtual task model leaving one or more empty slots in the virtual task model;
a visual testing function for enabling visual inspection of the virtual task model to determine whether the visual range of an empty slot is within a prescribed viewing range from one viewing perspective of the virtual task model, and that the configuration of the empty slot cannot be seen from one or more alternative viewing perspectives around the virtual task model;
a collider adding function to enable a collider to be added to:
(a) an empty slot, whereby the collider is substantially the same size as the removed virtual component model that fits the empty slot;
(b) a removed virtual component, so that the collider is bigger than and envelops the removed virtual component model;
the collider adding function including a collision function responsive to detecting a searching signal colliding with a collider and triggering an event for initiating further logics in response to the collision.

6. A virtual reality (VR) application for a VR platform for teaching and learning involving interaction between a teacher actor and a plurality of student actors, the VR application comprising:
a plurality of processes to enable the performance of a plurality of use cases enabling interaction between: (i) a teacher actor, (ii) a student actor, and (iii) spawned instances of the teacher actor and student actor and a plurality of interactive objects all forming part of a VR activity in a virtual environment using tools of a software development toolkit to perform a set of VR functionalites;
wherein the processes include:
(a) a plurality of teacher actor processes for synthesising interactions to implement case uses for a teacher actor to:
(i) organise a plurality of student actors to interact with an interactive task object and each other for teaching and learning collaboration and interactive skills in a collaborative and competitive manner, whereby the interactive task object is defined within a VR activity and comprises a plurality of interactive component objects;
(ii) control interaction associated with the VR activity and the competitive participation of student actors;
(iii) monitor the competitive participation of student actors associated with the VR activity; and
(b) a plurality of student actor processes for synthesising interactions to implement case uses for a student actor to participate in the VR activity including interacting to:
(i) gaze at an interactive object within the VR activity as a means of selecting the interactive object;
(ii) grab an interactive object within the VR activity as a means of holding the interactive object;
(iii) place a grabbed interactive object within the VR activity as a means of moving the interactive object;
(iv) rotate the head of a spawned instance of a student actor within the VR activity as a means of changing the view of the student actor within the virtual environment.

7. A method for providing engagement of a super actor with a plurality of user actors and enabling interaction and collaboration between them in association with interactive content in a VR environment, including avatars of the user actors, including:
providing logic and control operations of one or more groups of super actors and user actors, and networking functionalities between devices of the super actors and user actors in the VR environment;
providing content management services directly to the super actor and user actors within a group and the particular interactive content associated with the group;
activating a package comprising data technically describing one or more discreet virtual worlds, the data comprising a prescribed array of items corresponding to different item types, each virtual world being customised with items to provide prescribed functionality to the particular actor and to the particular content to be associated with the particular virtual world;
the item types being characterised within the devices of the user actors to create a virtual world capable of providing interaction and collaboration between:
(i) a plurality of user actors;
(ii) user actors in interactive content; and
(iii) super actors in user actors;
by including:
A. networking properties associated with interactive content providing synchronisation states substantially continuously to enable the interactive content to be synchronised amongst the devices;
B. group settings for the virtual world; and
C. a user interface for the devices to enable the devices to control the virtual world and trigger functionalities therein or associated therewith.

8. A method for teaching and learning involving interaction between a teacher actor and a plurality of student actors in a virtual reality (VR) environment, including:
for a teacher actor:
(i) organising a plurality of student actors to interact with an interactive task object and each other for teaching and learning collaboration and interactive skills in a collaborative and competitive manner, whereby the interactive task object is defined within a VR activity and comprises a plurality of interactive component objects;
(ii) controlling interaction associated with the VR activity and the competitive participation of student actors; and
(iii) monitoring the competitive participation of student actors associated with the VR activity; and
for a student actor to participate in the VR activity:
(i) gazing at an interactive object within the VR activity as a means of selecting the interactive object;
(ii) grabbing an interactive object within the VR activity as a means of holding the interactive object;
(iii) placing a grabbed interactive object within the VR activity as a means of moving the interactive object;
(iv) rotating the head of a spawned instance of a student actor within the VR activity as a means of changing the view of the student actor within the virtual environment.

9. A method for designing an interactive task object comprising interactive component objects for use in a virtual reality (VR) environment for teaching and learning involving interaction between a teacher actor and a plurality of student actors, the method including:
creating a virtual task model of an interactive task object;
dividing the virtual task model into virtual component models of interactive component objects;
removing selected virtual component models from the virtual task model leaving one or more empty slots in the virtual task model;
providing for visual inspection of the virtual task model to determine whether the visual range of an empty slot is within a prescribed viewing range from one viewing perspective of the virtual task model, and that the configuration of the empty slot cannot be seen from one or more alternative viewing perspectives around the virtual task model;
adding colliders to:
(a) an empty slot, whereby the collider is substantially the same size as the removed virtual component model that fits the empty slot;
(b) a removed virtual component, so that the collider is bigger than and envelops the removed virtual component model; and
detecting a searching signal colliding with a collider and triggering an event for initiating further logics in response to the collision.
